(19) United States
(12) Patent Application Publication
(10) Pub. No.: US 2015/0195717 A1
(43) Pub. Date: Jul. 9, 2015

(54) TECHNIQUES FOR COMMUNICATION BETWEEN INTERWORKING FUNCTION AND SHORT MESSAGE SERVICE NODES FOR DEVICE TRIGGER REPLACEMENT/RECALL

(71) Applicant: Puneet K. Jain, Hillsboro, OR (US)

(72) Inventor: Puneet K. Jain, Hillsboro, OR (US)

(21) Appl. No.: 14/499,124

(22) Filed: Sep. 27, 2014

Related U.S. Application Data
(60) Provisional application No. 61/924,194, filed on Jan. 6, 2014.

(51) Int. Cl. H04W 24/02; H04W 4/14; H04W 4/00

(52) U.S. Cl. CPC H04W 24/02; H04W 4/005; H04W 4/14

(57) ABSTRACT

Techniques to support device trigger replacement and/or recall are described. In one embodiment, for example, a machine-type communication interworking function (MTC-IWF) node may comprise logic, at least a portion of which is in hardware, the logic to receive a trigger adjustment request comprising a stored trigger identifier (ID), the trigger adjustment request constituting a request to adjust a stored device trigger associated with the stored trigger ID, select a trigger adjustment procedure for the stored device trigger based on the trigger adjustment request, and send a first T4 interface command over a T4 interface connection to initiate the selected trigger adjustment procedure. Other embodiments are described and claimed.

### RELATED CASE

This application claims priority to U.S. Provisional Patent Application No. 61/924,194, filed Jan. 6, 2014, the entirety of which is hereby incorporated by reference.

### TECHNICAL FIELD

Embodiments herein generally relate to operations performed by packet data network nodes in support of machine-type communications.

### BACKGROUND

In the context of machine-type communications (MTC) between a server and a wireless device such as a user equipment (UE), the server may send a device trigger to the wireless device, according to a device triggering function, in order to cause the wireless device to perform one or more operations. Such a device trigger may traverse various intermediate packet data network (PDN) nodes before reaching the wireless device. Depending on the location of the destination wireless device, the availability of wireless device resources, and/or other factors, a device trigger may be delivered without appreciable delay or may instead be temporarily stored at an intermediate node for some amount of time before being delivered to the destination wireless device. In some cases, by the time that the circumstances necessitating temporary storage of a device trigger have resolved themselves, it may no longer be desirable or necessary to deliver the device trigger. In such cases, it may be desirable to replace the device trigger with a substitute device trigger using a trigger replacement procedure or to simply recall the device trigger using a trigger recall procedure. In order to provide the server with such capabilities, the PDN nodes must be configured to communicate in such fashion as will enable them to appropriately relay trigger replacement and/or recall requests.

### BRIEF DESCRIPTION OF THE DRAWINGS

FIG. 1 illustrates an embodiment of a first operating environment.

FIG. 2 illustrates an embodiment of a first operating environment.

FIG. 3 illustrates an embodiment of a first apparatus and an embodiment of a first system.

FIG. 4A illustrates an embodiment of a first command.

FIG. 4B illustrates an embodiment of a second command.

FIG. 4C illustrates an embodiment of a third command.

FIG. 5A illustrates an embodiment of a fourth command.

FIG. 5B illustrates an embodiment of a fifth command.

FIG. 6A illustrates an embodiment of a sixth command.

FIG. 6B illustrates an embodiment of a seventh command.

FIG. 6C illustrates an embodiment of an eighth command.

FIG. 7A illustrates an embodiment of a ninth command.

FIG. 7B illustrates an embodiment of a tenth command.

FIG. 8A illustrates an embodiment of a first command message format.

FIG. 8B illustrates an embodiment of a second command message format.

FIG. 8C illustrates an embodiment of a third command message format.

FIG. 9A illustrates an embodiment of a fourth command message format.

FIG. 9B illustrates an embodiment of a fifth command message format.

FIG. 9C illustrates an embodiment of a sixth command message format.

FIG. 10A illustrates an embodiment of a first process.

FIG. 10B illustrates an embodiment of a first process.

FIG. 11A illustrates an embodiment of a first process.

FIG. 11B illustrates an embodiment of a first process.

FIG. 12 illustrates an embodiment of a second apparatus and an embodiment of a second system.

FIG. 13 illustrates an embodiment of a first logic flow.

FIG. 14 illustrates an embodiment of a second logic flow.

FIG. 15 illustrates an embodiment of a storage medium.

FIG. 16 illustrates an embodiment a device.

FIG. 17 illustrates an embodiment of a wireless network.

### DETAILED DESCRIPTION

Various embodiments may be generally directed to techniques to support device trigger replacement and/or recall. In one embodiment, for example, a machine-type communication interworking function (MTC-IWF) node may comprise logic, at least a portion of which is in hardware, the logic to receive a trigger adjustment request comprising a stored trigger identifier (ID), the trigger adjustment request constituting a request to adjust a stored device trigger associated with the stored trigger ID, select a trigger adjustment procedure for the stored device trigger based on the trigger adjustment request, and send a first T4 interface command over a T4 interface connection to initiate the selected trigger adjustment procedure. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), and/or 3GPP LTE-Advanced (LTE-A) technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, and/or IEEE 802.11ah standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards, and/or near-field communication (NFC) standards such as standards developed by the NFC Forum, including any revisions, progeny, and/or variants of any of the above. The embodiments are not limited to these examples.

In addition to transmission over one or more wireless connections, the techniques disclosed herein may involve transmission of content over one or more wired connections through one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

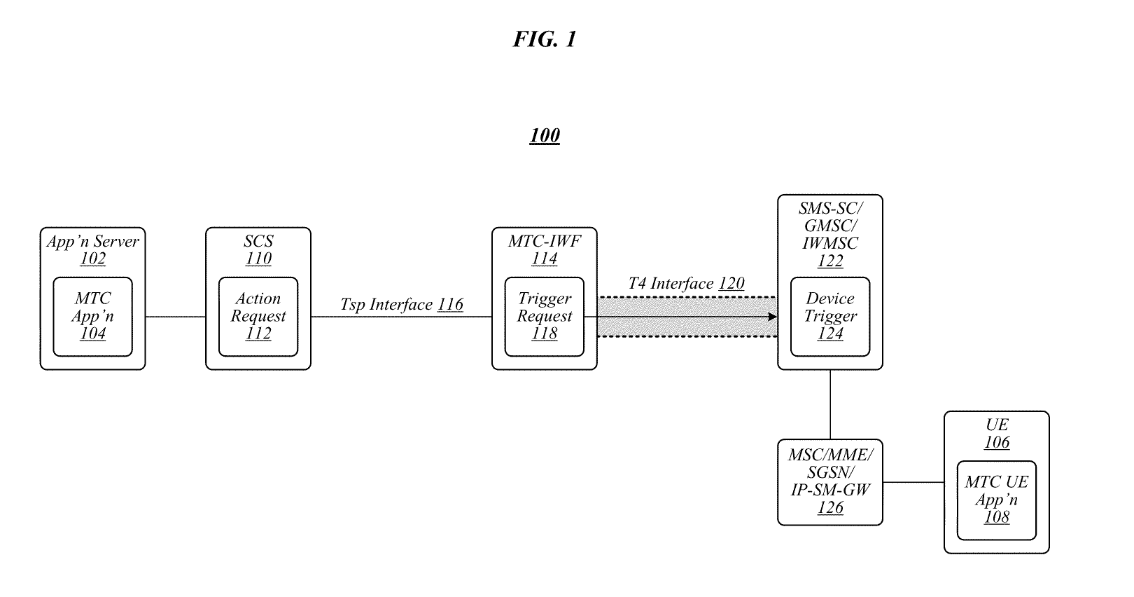

FIG. 1 illustrates an operating environment 100 such as may be representative of various embodiments. In operating environment 100, an application server 102 executes an MTC application 104, which may exchange one or more application-layer communications with an MTC UE application 108 executing on a UE 106. In some embodiments, UE 106 may comprise an unattended electronic device such as a sensor, meter, gauge, control, instrument, monitor, appliance, or other such device. In various other embodiments, UE 106 may comprise a consumer electronic device such as a mobile phone, a computer, an e-book reader, a personal digital assistant, or other consumer electronic device. In some embodiments, MTC application 104 and MTC UE application 108 may exchange communications in order to implement and/or manage the generation, collection, identification, selection, storage, and/or reporting of measurements, observations, or other data on the part of the UE 106. In various embodiments, such measurements, observations, or other data may describe characteristics and/or properties of UE 106 and/or its surroundings. In some embodiments, MTC application 104 and MTC UE application 108 may alternatively or additionally exchange communications for other purposes. The embodiments are not limited in this context.

In operating environment 100, MTC application 104 may make use of a device triggering function of a services capability server (SCS) 110 in order to cause UE 106 and/or MTC UE application 108 to perform one or more operations. According to the device triggering function, SCS 110 may send an action request 112 to an MTC interworking function (MTC-IWF) node 114 over a Tsp interface connection 116. In various embodiments, the action request 112 may comprise a Diameter protocol command for a Tsp interface Diameter application. In some embodiments, the action request 112 may comprise a Device-Action-Request (DAR) command. In various embodiments, the action request 112 may include a field containing a value that indicates that the action request 112 is a request for device triggering. For example, in some embodiments in which the action request 112 comprises a DAR command, the DAR command may include an Action-Type attribute-value pair (AVP) containing a value that indicates that the DAR is command is a request for device triggering. The embodiments are not limited in this context.

In response to action request 112, MTC-IWF node 114 may send a trigger request 118 over a T4 interface connection 120 to a short message service (SMS) service center (SMS-SC)/gateway mobile services switching center (GMSC)/interworking mobile services switching center (IWMSC) node 122. In various embodiments, the trigger request 118 may comprise a Diameter protocol command for a T4 interface Diameter application. For example, in some embodiments, the trigger request 118 may comprise a Device-Trigger-Request command. In response to the trigger request 118, SMS-SC/GMSC/IWMSC node 122 may generate and store a device trigger 124 for subsequent be delivery to the UE 106 via an MSC, a mobility management entity (MME), a serving general packet radio service support node (SGSN), or an internet protocol-short message gateway (IP-SM-GW) (collectively, MSC/MME/SGSN/IP-SM-GW) 126. In various embodiments, device trigger 124 may comprise a trigger payload that identifies the one or more operations desired by MTC application 104. In some embodiments, if device trigger 124 is delivered to UE 106, then UE 106 and/or MTC UE application 108 may perform the one or more operations identified in the trigger payload. The embodiments are not limited in this context.

In various embodiments, there may be a latency associated with the delivery of device trigger 124 to UE 106, such that device trigger 124 remains stored at SMS-SC/GMSC/IWMSC node 122 during a latency period prior to being retrieved and delivered to UE 106. In some embodiments, during such a latency period, MTC application 104 may determine that it is no longer desirable that UE 106 and/or MTC UE application 108 be instructed to perform the one or more operations identified in the payload of device trigger 124, and thus that that device trigger 124 should be withheld. In various such embodiments, MTC application 104 may determine that device trigger 124 should be replaced with an alternate device trigger comprising different instructions for UE 106 and/or MTC UE application 108. In some other embodiments, MTC application 104 may determine that no device trigger should be sent to UE 106, and thus that device trigger 124 should simply be recalled rather than being replaced.

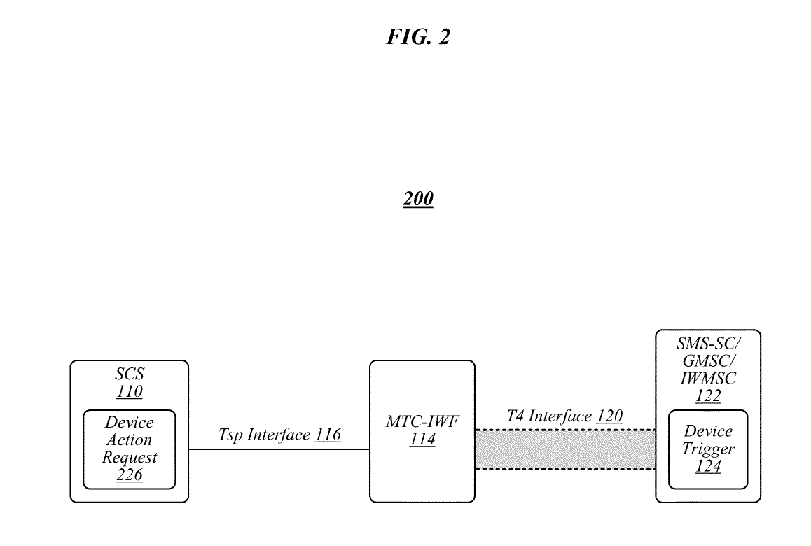

FIG. 2 illustrates an operating environment 200 such as may be representative of various embodiments in which MTC application 104 of FIG. 1 determines that device trigger 124 should be replaced or recalled. In operating environment 200, in order to effectuate a replacement or recall of the device trigger 124 that is pending at SMS-SC/GMSC/IWMSC node 122, SCS 110 sends a Device-Action-Request 226 to MTC-IWF node 114 over Tsp interface connection 116. In various embodiments, Device-Action-Request 226 may include an Action-Type AVP containing a value that indicates that the Device-Action-Request 226 is a request for trigger replacement or a value that indicates that the Device-Action-Request 226 is a request for trigger recall. The embodiments are not limited in this context.

According to the limitations of conventional systems, although Device-Action-Request 226 may notify MTC-IWF node 114 that device trigger 124 is to be replaced or recalled, MTC-IWF node 114 may have no way to communicate this information to SMS-SC/GMSC/IWMSC node 122 using T4 interface connection 120. More particularly, MTC-IWF node 114 may not be configured with commands, functions, or capabilities that enable it to communicate over T4 interface connection 120 in order to notify SMS-SC/GMSC/IWMSC node 122 that device trigger 124 is to be replaced or recalled. Likewise, SMS-SC/GMSC/IWMSC node 122 may not be configured with commands, functions, or capabilities that enable it to properly acknowledge and/or respond to such a notification. For example, in a conventional system in which MTC-IWF node 114 is configured to use a set of Diameter protocol commands for a T4 interface Diameter application to communicate over T4 interface connection 120, that set of Diameter protocol commands for the T4 interface Diameter application may not include a command that enables MTC-IWF node 114 to relay a trigger replacement or recall request to SMS-SC/GMSC/IWMSC node 122 over T4 interface connection 120 or a command that enables SMS-SC/GMSC/IWMSC node 122 to answer such a request.

Disclosed herein are techniques to support device trigger replacement and recall such as may address such limitations of conventional systems. According to some such techniques, an MTC-IWF node and an SMS-SC/GMSC/IWMSC node may be configured to communicate with each other according to a protocol that enables the MTC-IWF node to relay trigger replacement and/or recall requests to the SMS-SC/GMSC/IWMSC node over a T4 interface connection and enables the SMS-SC/GMSC/IWMSC node to answer such requests using the T4 interface connection. In various embodiments, the MTC-IWF node and the SMS-SC/GMSC/IWMSC node may be arranged to utilize Diameter protocol commands that are configured to convey trigger replacement and/or recall requests, and/or acknowledgments thereof, over T4 interface connections. The embodiments are not limited in this context.

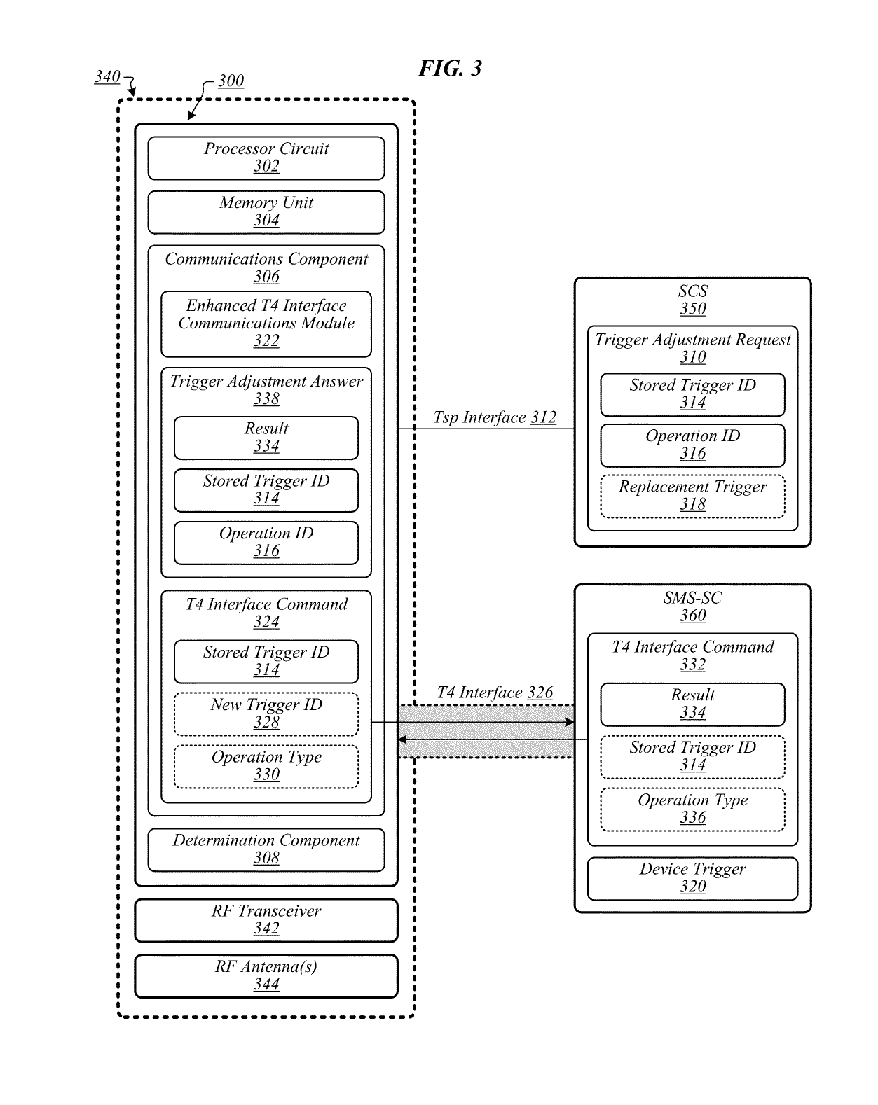

FIG. 3 illustrates a block diagram of an apparatus 300. Apparatus 300 may be representative of an MTC-IWF node such as may be configured in some embodiments to communicate over a T4 interface connection according to trigger replacement and recall support techniques disclosed herein. Apparatus 300 may be representative of MTC-IWF 114 node of FIGS. 1 and 2 in various embodiments. As shown in FIG. 3, apparatus 300 comprises multiple elements including a processor circuit 302, a memory unit 304, a communications component 306, and a determination component 308. The embodiments, however, are not limited to the type, number, or arrangement of elements shown in this figure.

In some embodiments, apparatus 300 may comprise processor circuit 302. Processor circuit 302 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 302 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 302 may be implemented as a general purpose processor, such as a processor made by Intel® Corporation, Santa Clara, Calif. The embodiments are not limited in this context.

In various embodiments, apparatus 300 may comprise or be arranged to communicatively couple with a memory unit 304. Memory unit 304 may be implemented using any machine-readable or computer-readable media capable of storing data, including both volatile and non-volatile memory. For example, memory unit 304 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 304 may be included on the same integrated circuit as processor circuit 302, or alternatively some portion or all of memory unit 304 may be disposed on an integrated circuit or other medium, for example a hard disk drive, that is external to the integrated circuit of processor circuit 302. Although memory unit 304 is comprised within apparatus 300 in FIG. 3, memory unit 304 may be external to apparatus 300 in some embodiments. The embodiments are not limited in this context.

In various embodiments, apparatus 300 may comprise a communications component 306. Communications component 306 may comprise logic, circuitry, and/or instructions operative to send messages to one or more remote devices and/or to receive messages from one or more remote devices. In some embodiments, communications component 306 may be operative to send and/or receive messages over one or more wired connections, one or more wireless connections, or a combination of both. In various embodiments, communications component 306 may additionally comprise logic, circuitry, and/or instructions operative to perform various operations in support of such communications. Examples of such operations may include selection of transmission and/or reception parameters and/or timing, packet and/or protocol data unit (PDU) construction and/or deconstruction, encoding and/or decoding, error detection, and/or error correction. The embodiments are not limited to these examples.

In some embodiments, apparatus 300 may comprise a determination component 308. Determination component 308 may comprise logic, circuitry, and/or instructions operative to perform various types of determinations and/or decisions in support of MTC operations performed by apparatus 300. In various embodiments, determination component 308 may be operative to perform one or more determinations and/or decisions in support of trigger management operations on the part of apparatus 300 and/or one or more external nodes. The embodiments are not limited in this context.

FIG. 3 also illustrates a block diagram of a system 340. System 340 may comprise any of the aforementioned elements of apparatus 300. System 340 may further comprise a radio frequency (RF) transceiver 342. RF transceiver 342 may comprise one or more radios capable of transmitting and receiving signals using various suitable wireless communications techniques. Such techniques may involve communications across one or more wireless networks. Exemplary wireless networks include (but are not limited to) cellular radio access networks, wireless local area networks (WLANs), wireless personal area networks (WPANs), wireless metropolitan area network (WMANs), and satellite networks. In communicating across such networks, RF transceiver 342 may operate in accordance with one or more applicable standards in any version. The embodiments are not limited in this context.

In some embodiments, system 340 may comprise one or more RF antennas 344. Examples of any particular RF antenna 344 may include, without limitation, an internal antenna, an omni-directional antenna, a monopole antenna, a dipole antenna, an end-fed antenna, a circularly polarized antenna, a micro-strip antenna, a diversity antenna, a dual antenna, a tri-band antenna, a quad-band antenna, and so forth. In various embodiments, RF transceiver 342 may be operative to send and/or receive messages and/or data using one or more RF antennas 344. The embodiments are not limited in this context.

During general operation of apparatus 300 and/or system 340, communications component 306 may be operative to receive a trigger adjustment request 310 from an SCS 350. In some embodiments, SCS 350 may be the same as or similar to SCS 110 of FIGS. 1 and 2. In various embodiments, communications component 306 may be operative to receive trigger adjustment request 310 from SCS 350 via a Tsp interface connection 312. In some embodiments, Tsp interface connection 312 may be the same as or similar to Tsp interface connection 116 of FIGS. 1 and 2. In various embodiments, trigger adjustment request 310 may comprise a Diameter protocol command for a Tsp interface Diameter application. In some embodiments, trigger adjustment request 310 may comprise a DAR command. In various embodiments, trigger adjustment request 310 may be the same as or similar to Device-Action-Request 226 of FIG. 2.

In some embodiments, trigger adjustment request 310 may comprise a stored trigger identifier (ID) 314. Stored trigger ID 314 may comprise an identifier associated with a device trigger 320 that has been stored at an SMS-SC 360. SMS-SC 360 may be the same as or similar to SMS-SC/GMSC/IWMSC node 122 of FIGS. 1 and 2. In various embodiments in which trigger adjustment request 310 comprises a Tsp interface Diameter protocol command, such as a DAR command, stored trigger ID 314 may comprise an AVP of the Tsp interface Diameter protocol command, such as a Reference-Number AVP or an Old-Reference-Number AVP. In some embodiments, trigger adjustment request 310 may comprise an operation ID 316. Operation ID 316 may comprise a value that indicates that trigger adjustment request 310 is a request for trigger replacement or a value that indicates that the trigger adjustment request 310 is a request for trigger recall. In various embodiments in which trigger adjustment request 310 comprises a Tsp interface Diameter protocol command, operation ID 316 may comprise an AVP of the Tsp interface Diameter protocol command, such as an Action-Type AVP. The embodiments are not limited in this context.

In some embodiments in which trigger adjustment request 310 is a request for trigger replacement, trigger adjustment request 310 may comprise a replacement trigger 318. Replacement trigger 318 may comprise a device trigger with which device trigger 320 is to be replaced, or may comprise information useable to generate such a replacement trigger. In various embodiments in which trigger adjustment request 310 comprises a Tsp interface Diameter protocol command, replacement trigger 318 may comprise an AVP of that Tsp interface Diameter protocol command. For example, in some embodiments, replacement trigger 318 may comprise a Trigger-Data AVP. In various embodiments, such as embodiments in which trigger adjustment request 310 is not a request for trigger replacement, trigger adjustment request 310 may not comprise replacement trigger 318. In some embodiments, SCS 350 may include or exclude replacement trigger 318 from trigger adjustment request 310 based on whether trigger adjustment request 310 is a request for trigger replacement or a request for trigger recall. Replacement trigger 318 is depicted with a dotted border in FIG. 3 in order to reflect such a scenario. However, it is to be understood that the embodiments are not limited in this context.

In various embodiments, determination component 308 may be operative to identify device trigger 320 and SMS-SC 360 based on trigger adjustment request 310. In some embodiments, determination component 308 may be operative to identify device trigger 320 as a device trigger that corresponds to the stored trigger ID 314 comprised in trigger adjustment request 310. In various embodiments, determination component 308 may be operative to identify SMS-SC 360 as an SMS-SC to which it previously submitted device trigger 320. The embodiments are not limited in this context.

In some embodiments, in response to trigger adjustment request 310, determination component 308 may be operative to determine whether to initiate a trigger adjustment procedure. In various embodiments, determination component 308 may be operative to determine whether to initiate a trigger adjustment procedure based on the identity of the SCS 350 from which trigger adjustment request 310 is received. In some embodiments, for example, determination component 308 may be operative to determine whether SCS 350 is authorized to perform device triggering to a UE to which device trigger 320 is directed. In such embodiments, if SCS 350 is not authorized to perform device triggering to the UE, determination component 308 may be operative to determine not to initiate a trigger adjustment procedure. On the other hand, if SCS 350 is authorized to perform device triggering to the UE, determination component 308 may be operative to determine to initiate a trigger adjustment procedure. The embodiments are not limited in this context.

In various embodiments, determination component 308 may be operative to determine to initiate a trigger adjustment procedure, and may be operative to select from among multiple possible trigger adjustment procedures based on the operation ID 316 comprised in trigger adjustment request 310. In some embodiments, determination component 308 may be operative to select either a trigger replacement procedure or a trigger recall procedure based on operation ID 316. In various embodiments, determination component 308 may be operative to select a trigger replacement procedure in response to a determination that operation ID 316 indicates that trigger adjustment request 310 comprises a request for trigger replacement. For example, if trigger adjustment request 310 comprises a Tsp interface Diameter protocol command and operation ID 316 comprises an Action-Type AVP, determination component 308 may be operative to select a trigger replacement procedure in response to a determination that the Action-Type AVP comprises a value indicating a trigger replacement request. In some embodiments, determination component 308 may be operative to select a trigger recall procedure in response to a determination that operation ID 316 indicates that trigger adjustment request 310 comprises a request for trigger recall. For example, if trigger adjustment request 310 comprises a Tsp interface Diameter protocol command and operation ID 316 comprises an Action-Type AVP, determination component 308 may be operative to select a trigger recall procedure in response to a determination that the Action-Type AVP comprises a value indicating a trigger recall request. The embodiments are not limited to these examples.

In various embodiments, communications component 306 may comprise an enhanced T4 interface communications module 322. Enhanced T4 interface communications module 322 may comprise logic, circuitry, and/or instructions via which communications component 306 is configured to communicate according to an enhanced T4 interface communications protocol that enables the conveyance of trigger replacement and/or recall requests, and/or acknowledgments thereof, over T4 interface connections. In some embodiments, communications component 306 may be operative to use a T4 interface command 324 of the enhanced T4 interface communications protocol to initiate a trigger adjustment procedure that determination component 308 has selected for device trigger 320. In various embodiments, the T4 interface command 324 may comprise the stored trigger ID 314 for device trigger 320. In some embodiments, communications component 306 may be operative to send the T4 interface command 324 to SMS-SC 360 over a T4 interface connection 326. In various embodiments, T4 interface connection 326 may be the same as or similar to T4 interface connection 120 of FIGS. 1 and 2. In some embodiments, T4 interface command 324 may comprise a Diameter protocol command for a T4 interface Diameter application corresponding to the enhanced T4 interface communications protocol. In various embodiments, communications component 306 may be operative to determine a format for T4 interface command 324 based on the type of trigger adjustment procedure that determination component 308 has selected. In some embodiments, determining the format for T4 interface command 324 may involve determining a type of command that T4 interface command 324 is to comprise, determining what fields T4 interface command 324 is to include, and/or determining values that one or more such fields are to contain. The embodiments are not limited in this context.

In various embodiments, determination component 308 may be operative to select a trigger replacement procedure in response to trigger adjustment request 310, and communications component 306 may be operative to initiate the trigger replacement procedure by sending a T4 interface command 324 of a format that the enhanced T4 interface communications protocol designates for use in conjunction with trigger replacement. In some embodiments, in addition to the stored trigger ID 314 for the device trigger 320 to be replaced, the T4 interface command 324 may include a new trigger ID 328 comprising an identifier associated with a device trigger with which the device trigger 320 is to be replaced. In various embodiments in which trigger adjustment request 310 comprises replacement trigger 318, new trigger ID 328 may comprise an identifier associated with replacement trigger 318. The embodiments are not limited in this context.

In some embodiments, the T4 interface command 324 may comprise a legacy T4 interface Diameter protocol command adapted with an enhanced format that makes it suitable for use in trigger replacement procedure initiation. For example, in various embodiments, communications component 306 may be operative to initiate the trigger replacement procedure by sending an enhanced Device-Trigger-Request T4 interface Diameter protocol command that comprises an Old-Reference-Number AVP that identifies device trigger 320 and comprises a Reference-Number AVP that identifies the new device trigger with which device trigger 320 is to be replaced. In some other embodiments, the T4 interface command 324 may be of a new type that the enhanced T4 interface communications protocol defines for use specifically in conjunction with trigger replacement. For example, in various embodiments, the enhanced T4 interface communications protocol may newly define a Device-Trigger-Replace-Request T4 interface Diameter protocol command, and communications component 306 may send such a command in order to initiate the trigger replacement procedure. In some such embodiments, the Device-Trigger-Replace-Request command may comprise an Old-Reference-Number AVP that identifies device trigger 320 and a Reference-Number AVP that identifies the new device trigger with which device trigger 320 is to be replaced. The embodiments are not limited to these examples.

In various embodiments, communications component 306 may send a T4 interface command 324 that explicitly indicates that it constitutes a trigger replacement request. In some embodiments, for example, T4 interface command 324 may comprise a new dedicated command that the enhanced T4 interface communications protocol designates specifically for use in initiating trigger replacement. In another example, in various embodiments, T4 interface command 324 may include an operation type field 330 comprising a value that explicitly indicates that T4 interface command 324 constitutes a trigger replacement request. In some other embodiments, information comprised in T4 interface command 324 may implicitly indicate that T4 interface command 324 constitutes a trigger replacement request. For example, according to the enhanced T4 interface communications protocol in various embodiments, the inclusion of both stored trigger ID 314 and new trigger ID 328 in T4 interface command 324 may comprise an implicit indication that T4 interface command 324 constitutes a trigger replacement request. The embodiments are not limited in this context.

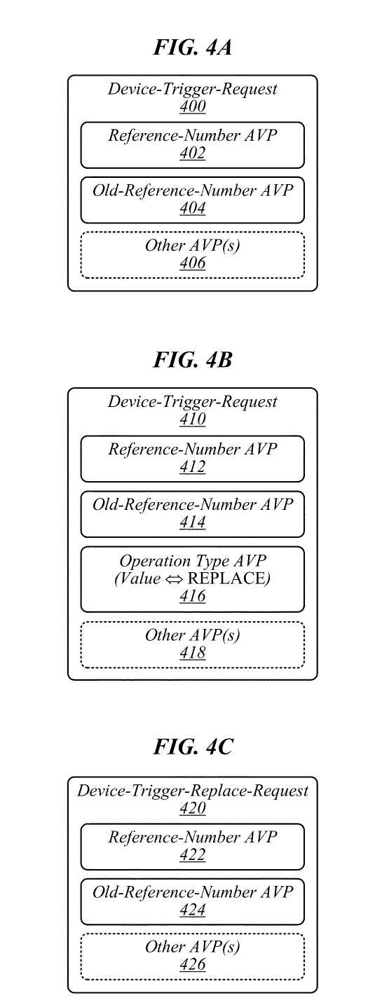

FIG. 4A illustrates an example of a command that may be representative of a T4 interface command 324 that communications component 306 of FIG. 3 may send in some embodiments to initiate a trigger replacement procedure for device trigger 320. More particularly, FIG. 4A illustrates an example of a Device-Trigger-Request command 400 such as may be representative of a command of an enhanced T4 interface Diameter protocol with which communications component 306 of FIG. 3 may be configured by enhanced T4 interface communications module 322 in various embodiments. In the example of FIG. 4A, Device-Trigger-Request 400 comprises a Reference-Number AVP 402. In some embodiments, Reference-Number AVP 402 may comprise a reference number of a device trigger with which a previously stored device trigger is to be replaced. Device-Trigger-Request 400 also comprises an Old-Reference-Number AVP 404. In various embodiments, Old-Reference-Number AVP 404 may comprise a reference number of the previously stored device trigger that is intended to be replaced. In some embodiments, the inclusion of both Reference-Number AVP 402 and Old-Reference-Number AVP 404 in Device-Trigger-Request 400 may comprise an implicit indication that Device-Trigger-Request 400 is intended to initiate a trigger replacement procedure. In various embodiments, in addition to Reference-Number AVP 402 and Old-Reference-Number AVP 404, Device-Trigger-Request 400 may comprise one or more other AVPs 406. For example, in some embodiments, Device-Trigger-Request 400 may also comprise a User-Identifier AVP that identifies the UE with which the previously stored and new triggers are associated, an SCS-Identity AVP that identifies the SCS that has requested the trigger replacement, and a short message relay layer protocol user information (SM-RP-UI) AVP that comprises the new trigger. The embodiments are not limited to these examples.

FIG. 4B illustrates a second example of a command that may be representative of a T4 interface command 324 that communications component 306 of FIG. 3 may send in various embodiments to initiate a trigger replacement procedure for device trigger 320. More particularly, FIG. 4B illustrates an example of a Device-Trigger-Request command 410 such as may be representative of a command of an enhanced T4 interface Diameter protocol with which communications component 306 of FIG. 3 may be configured by enhanced T4 interface communications module 322 in some embodiments. In the example of FIG. 4B, Device-Trigger-Request 410 comprises a Reference-Number AVP 412 and an Old-Reference-Number AVP 414, which may be the same as or similar to Reference-Number AVP 402 and Old-Reference-Number AVP 404 of FIG. 4A, respectively. Device-Trigger-Request 410 also comprises an operation type AVP 416, which contains a value indicating that Device-Trigger-Request 410 is intended to initiate a trigger replacement procedure. In various embodiments, operation type AVP 416 may be the same as or similar to operation type field 330 in FIG. 3. In some embodiments, operation type AVP 416 may be referred by other names (e.g. Action Type, Trigger Type, Trigger Action etc.). In some embodiments, Device-Trigger-Request command 410 may also comprise one or more other AVPs 418. Examples of other AVPs 418 may include, without limitation, any of the examples previously mentioned with respect to other AVPs 406 of FIG. 4A. The embodiments are not limited in this context.

FIG. 4C illustrates a third example of a command that may be representative of a T4 interface command 324 that communications component 306 of FIG. 3 may send in various embodiments to initiate a trigger replacement procedure for device trigger 320. More particularly, FIG. 4C illustrates an example of a Device-Trigger-Replacement-Request command 420 such as may be representative of a newly defined command of an enhanced T4 interface Diameter protocol with which communications component 306 of FIG. 3 may be configured by enhanced T4 interface communications module 322 in some embodiments. In the example of FIG. 4C, Device-Trigger-Replacement-Request 420 comprises a Reference-Number AVP 422 and an Old-Reference-Number AVP 424, which may be the same as or similar to Reference-Number AVPs 402 and 412 and Old-Reference-Number AVPs 404 and 414 of FIGS. 4A and 4B, respectively. In various embodiments, Device-Trigger-Replacement-Request 420 also may comprise one or more other AVPs 426, examples of which may include, without limitation, any of the examples previously mentioned with respect to other AVPs 406 and 418 of FIGS. 4A and 4B, respectively. Unlike Device-Trigger-Requests 400 and 410 of FIGS. 4A and 4B, Device-Trigger-Replacement-Request 420 may comprise a T4 interface Diameter protocol command designated specifically for use in initiating device trigger replacement. The embodiments are not limited in this context.

Returning to FIG. 3, in some embodiments, rather than selecting a trigger replacement procedure, determination component 308 may be operative to select a trigger recall procedure in response to trigger adjustment request 310. In various embodiments, communications component 306 may be operative to initiate the trigger recall procedure by sending a T4 interface command 324 of a format that the enhanced T4 interface communications protocol designates for use in conjunction with trigger recall. In some embodiments, the T4 interface command 324 may comprise a legacy T4 interface Diameter protocol command adapted with an enhanced format that makes it suitable for use in trigger recall procedure initiation. For example, in various embodiments, communications component 306 may be operative to initiate the trigger recall procedure by sending an enhanced Device-Trigger-Request T4 interface Diameter protocol command that comprises a Reference-Number AVP or Old-Reference-Number AVP that identifies device trigger 320 and includes an operation type field 330 comprising a value that indicates that T4 interface command 324 constitutes a trigger recall request. In some other embodiments, the T4 interface command 324 may be of a new dedicated type that the enhanced T4 interface communications protocol designates specifically for use in initiating trigger recall. For example, in various embodiments, the enhanced T4 interface communications protocol may newly define a Device-Trigger-Recall-Request T4 interface Diameter protocol command, and communications component 306 may send such a command in order to initiate the trigger recall procedure. In some such embodiments, the Device-Trigger-Recall-Request command may comprise a Reference-Number AVP or Old-Reference-Number AVP that identifies device trigger 320. The embodiments are not limited to these examples.

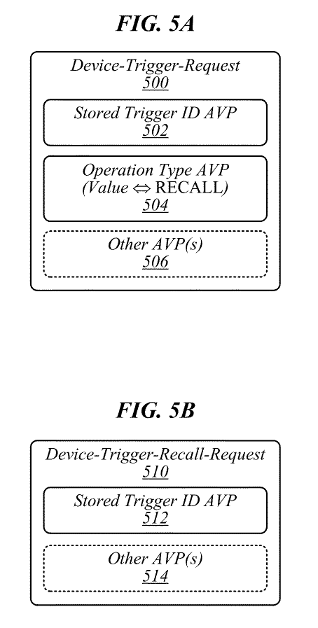

FIG. 5A illustrates an example of a command that may be representative of a T4 interface command 324 that communications component 306 of FIG. 3 may send in various embodiments to initiate a trigger recall procedure for device trigger 320. More particularly, FIG. 5A illustrates an example of a Device-Trigger-Request command 500 such as may be representative of a command of an enhanced T4 interface Diameter protocol with which communications component 306 of FIG. 3 may be configured by enhanced T4 interface communications module 322 in some embodiments. In the example of FIG. 5A, Device-Trigger-Request 500 comprises a stored trigger ID AVP 502. In various embodiments, stored trigger ID AVP 502 may comprise a reference number of a previously stored device trigger to be recalled. In some embodiments, stored trigger ID AVP 502 may comprise a Reference-Number AVP or an Old-Reference-Number AVP. In various embodiments, stored trigger ID AVP 502 may be the same as or similar to stored trigger ID field 314 in FIG. 3. Device-Trigger-Request 500 also comprises an operation type AVP 504, which contains a value indicating that Device-Trigger-Request 500 is intended to initiate a trigger recall procedure. In some embodiments, operation type AVP 504 may be the same as or similar to operation type field 330 in FIG. 3. In some embodiments, operation type AVP 504 may be referred by other names (e.g. Action Type, Trigger Type, Trigger Action etc.). In various embodiments, Device-Trigger-Request 500 may also comprise one or more other AVPs 506. For example, in some embodiments, Device-Trigger-Request 500 may also comprise a User-Identifier AVP that identifies the UE with which the previously stored trigger is associated and an SCS-Identity AVP that identifies the SCS that has requested the trigger recall. The embodiments are not limited to these examples.

FIG. 5B illustrates a second example of a command that may be representative of a T4 interface command 324 that communications component 306 of FIG. 3 may send in various embodiments to initiate a trigger recall procedure for device trigger 320. More particularly, FIG. 5B illustrates an example of a Device-Trigger-Recall-Request command 510 such as may be representative of a newly defined command of an enhanced T4 interface Diameter protocol with which communications component 306 of FIG. 3 may be configured by enhanced T4 interface communications module 322 in some embodiments. In the example of FIG. 5B, Device-Trigger-Recall-Request 510 comprises a stored trigger ID AVP 512, which may be the same as or similar to stored trigger ID AVP 502 of FIG. 5A. In various embodiments, Device-Trigger-Recall-Request 510 also may comprise one or more other AVPs 514, examples of which may include, without limitation, any of the examples previously mentioned with respect to other AVPs 506 of FIG. 5A. Unlike Device-Trigger-Request 500 of FIG. 5A, Device-Trigger-Recall-Request 510 may comprise a T4 interface Diameter protocol command specifically designated for use in initiating device trigger recall. The embodiments are not limited in this context.

Returning to FIG. 3, in some embodiments, communications component 306 may be operative to send T4 interface command 324 over T4 interface connection 326 to SMS-SC 360, and SMS-SC 360 may be operative to process T4 interface command 324. In various embodiments, the results of this processing may depend on whether device trigger 320 is still pending at SMS-SC 360 or instead has already been delivered to its destination UE. In some embodiments, if device trigger 320 has already been delivered and is no longer pending at SMS-SC 360, a trigger replacement or recall failure may result. In various embodiments, if device trigger 320 is still pending at SMS-SC 360, then it may be possible for SMS-SC 360 to successfully replace or recall device trigger 320 as appropriate according to T4 interface command 324. It is worthy of note that due to other factors in some embodiments, it may be possible for trigger replacement or recall to fail even when device trigger 320 is still pending at SMS-SC 360 upon its receipt of T4 interface command 324. As such, in various embodiments in which device trigger 320 is still pending at SMS-SC 360 upon its receipt of T4 interface command 324, the processing at SMS-SC 360 may result in a successful trigger replacement or recall or instead may result in a trigger replacement or recall failure. The embodiments are not limited in this context.

In some embodiments, in order to report the results of its processing of T4 interface command 324, SMS-SC 360 may be operative to send a T4 interface command 332 to apparatus 300 and/or system 340 over T4 interface connection 326. In various embodiments, T4 interface command 332 may comprise a result field 334 that contains information describing the results of the trigger adjustment procedure initiated via T4 interface command 324. In some embodiments, T4 interface command 332 may also comprise the stored trigger ID 314 of the device trigger 320 associated with that trigger adjustment procedure. In various embodiments, T4 interface command 332 may comprise a Diameter protocol command for a T4 interface Diameter application corresponding to the enhanced T4 interface communications protocol with which enhanced T4 interface communications module 322 configures communications component 306. In some embodiments, SMS-SC 360 may be operative to determine a format for T4 interface command 332 based on the type of trigger adjustment procedure initiated via T4 interface command 324. In various embodiments, T4 interface command 332 may include an operation type field 336 comprising a value that indicates that T4 interface command 332 constitutes a report of the results of a trigger replacement or recall procedure. In some embodiments, T4 interface command 332 may comprise a legacy T4 interface Diameter protocol command adapted with an enhanced format that makes it suitable for use in reporting the results of the trigger adjustment procedure initiated via T4 interface command 324. In various other embodiments, T4 interface command 332 may be of a new type that the enhanced T4 interface communications protocol defines for use in reporting the results of trigger adjustment procedures of the type corresponding to T4 interface command 324. The embodiments are not limited in this context.

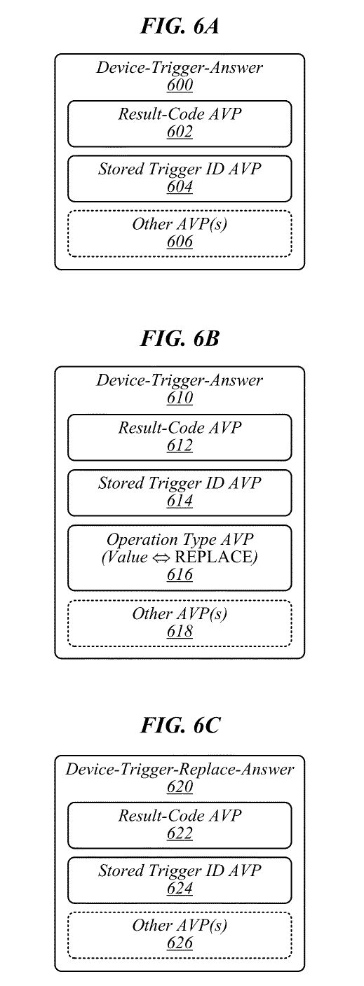

FIG. 6A illustrates an example of a command that may be representative of a T4 interface command 332 that SMS-SC 360 of FIG. 3 may send in some embodiments to report the results of a trigger replacement or recall procedure for device trigger 320. More particularly, FIG. 6A illustrates an example of a Device-Trigger-Answer command 600 such as may be representative of a command of an enhanced T4 interface Diameter protocol with which communications component 306 of FIG. 3 may be configured by enhanced T4 interface communications module 322 in various embodiments. In the example of FIG. 6A, Device-Trigger-Answer 600 comprises a Result-Code AVP 602 and a stored trigger ID AVP 604. In some embodiments, stored trigger ID AVP 604 may comprise a reference number of the device trigger for which a replacement or recall procedure was initiated. In various embodiments, stored trigger ID AVP 604 may comprise a Reference-Number AVP or an Old-Reference-Number AVP. In some embodiments, stored trigger ID AVP 604 may be the same as or similar to stored trigger ID field 314 in FIG. 3. In various embodiments, Result-Code AVP 602 may comprise a Diameter protocol result code indicating a result of the replacement or recall procedure for the device trigger corresponding to stored trigger ID AVP 604.

In some embodiments, if the replacement or recall procedure has been successful, Result-Code AVP 602 may comprise a Diameter protocol result code that indicates success. In various embodiments, if the replacement or recall procedure has failed, Result-Code AVP 602 may comprise a newly-defined result code of the enhanced T4 interface Diameter protocol that indicates trigger replacement or recall failure. In some embodiments, for example, the enhanced T4 interface Diameter protocol may define a result code ‘5533’ that indicates trigger replacement failure, and Result-Code AVP 602 may comprise that code ‘5533’ to indicate that a replacement procedure has failed for the device trigger corresponding to stored trigger ID AVP 604. In another example, in various embodiments, the enhanced T4 interface Diameter protocol may define a result code ‘5534’ that indicates trigger recall failure, and Result-Code AVP 602 may comprise that code ‘5534’ to indicate that a recall procedure has failed for the device trigger corresponding to stored trigger ID AVP 604. In some embodiments, Device-Trigger-Answer 600 may also comprise one or more other AVPs 606. For example, in various embodiments, Device-Trigger-Answer 600 may comprise a Supported-Features AVP that contains a list of features supported by an origin host. The embodiments are not limited to this example.

FIG. 6B illustrates an example of a command that may be representative of a T4 interface command 332 that SMS-SC 360 of FIG. 3 may send in some embodiments to report the results of a trigger replacement procedure for device trigger 320. More particularly, FIG. 6B illustrates an example of a Device-Trigger-Answer command 610 such as may be representative of a command of an enhanced T4 interface Diameter protocol with which communications component 306 of FIG. 3 may be configured by enhanced T4 interface communications module 322 in various embodiments. In the example of FIG. 6B, Device-Trigger-Answer 610 comprises a Result-Code AVP 612, a stored trigger ID AVP 614, and an operation type AVP 616. In some embodiments, stored trigger ID AVP 614 may comprise a reference number of the device trigger for which a replacement procedure was initiated. In various embodiments, stored trigger ID AVP 614 may comprise a Reference-Number AVP or an Old-Reference-Number AVP. In some embodiments, stored trigger ID AVP 614 may be the same as or similar to stored trigger ID field 314 in FIG. 3. In various embodiments, Result-Code AVP 612 may comprise a Diameter protocol result code indicating a result of the replacement procedure for the device trigger corresponding to stored trigger ID AVP 614. In some embodiments, if the replacement procedure has been successful, Result-Code AVP 612 may comprise a Diameter protocol result code that indicates success. In various embodiments, if the replacement procedure has failed, Result-Code AVP 612 may comprise a newly-defined result code of the enhanced T4 interface Diameter protocol that indicates trigger replacement failure, such as the aforementioned result code ‘5531’ Operation type AVP 616 contains a value indicating that Device-Trigger-Answer 610 is intended to report the results of a trigger replacement procedure. In some embodiments, operation type AVP 616 may be the same as or similar to operation type field 336 in FIG. 3. In various embodiments, Device-Trigger-Answer 610 may also comprise one or more other AVPs 618. Examples of other AVPs 618 may include, without limitation, the example previously mentioned with respect to other AVPs 606 of FIG. 6A. The embodiments are not limited in this context.

FIG. 6C illustrates a second example of a command that may be representative of a T4 interface command 332 that SMS-SC 360 of FIG. 3 may send in some embodiments to report the results of a trigger replacement procedure for device trigger 320. More particularly, FIG. 6C illustrates an example of a Device-Trigger-Replacement-Answer command 620 such as may be representative of a newly defined command of an enhanced T4 interface Diameter protocol with which communications component 306 of FIG. 3 may be configured by enhanced T4 interface communications module 322 in various embodiments. In the example of FIG. 6C, Device-Trigger-Replacement-Answer 620 comprises a Result-Code AVP 622 and stored trigger ID AVP 624, which may be the same as or similar to Result-Code AVP 612 and stored trigger ID AVP 614 of FIG. 6B, respectively. In some embodiments, Device-Trigger-Replacement-Answer 620 also may comprise one or more other AVPs 626, examples of which may include, without limitation, the example previously mentioned with respect to other AVPs 606 and 618 of FIGS. 6A and 6B, respectively. Unlike Device-Trigger-Answer 610 of FIG. 6B, Device-Trigger-Replacement-Answer 620 may comprise a T4 interface Diameter protocol command specifically designated for use in reporting the results of device trigger replacement procedures. The embodiments are not limited in this context.

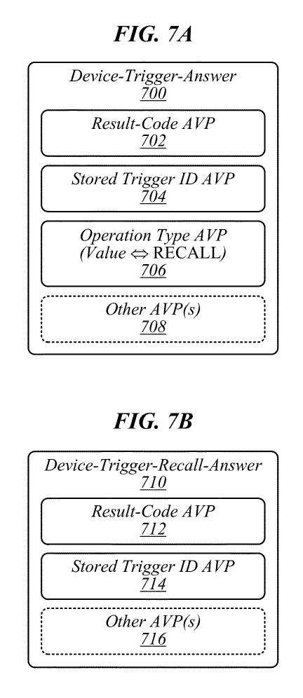

FIG. 7A illustrates an example of a command that may be representative of a T4 interface command 332 that SMS-SC 360 of FIG. 3 may send in various embodiments to report the results of a trigger recall procedure for device trigger 320. More particularly, FIG. 7A illustrates an example of a Device-Trigger-Answer command 700 such as may be representative of a command of an enhanced T4 interface Diameter protocol with which communications component 306 of FIG. 3 may be configured by enhanced T4 interface communications module 322 in some embodiments. In the example of FIG. 7A, Device-Trigger-Answer 700 comprises a Result-Code AVP 702, a stored trigger ID AVP 704, and an operation type AVP 706. In various embodiments, stored trigger ID AVP 704 may comprise a reference number of the device trigger for which a recall procedure was initiated. In some embodiments, stored trigger ID AVP 704 may comprise a Reference-Number AVP or an Old-Reference-Number AVP. In various embodiments, stored trigger ID AVP 704 may be the same as or similar to stored trigger ID field 314 in FIG. 3. In some embodiments, Result-Code AVP 702 may comprise a Diameter protocol result code indicating a result of the recall procedure for the device trigger corresponding to stored trigger ID AVP 704. In various embodiments, if the recall procedure has been successful, Result-Code AVP 702 may comprise a Diameter protocol result code that indicates success. In some embodiments, if the recall procedure has failed, Result-Code AVP 702 may comprise a newly-defined result code of the enhanced T4 interface Diameter protocol that indicates trigger recall failure, such as the aforementioned result code ‘5534.’ Operation type AVP 706 contains a value indicating that Device-Trigger-Answer 700 is intended to report the results of a trigger recall procedure. In various embodiments, operation type AVP 706 may be the same as or similar to operation type field 336 in FIG. 3. In some embodiments, Device-Trigger-Answer 700 may also comprise one or more other AVPs 708. Examples of other AVPs 708 may include, without limitation, the example previously mentioned with respect to other AVPs 606, 618, and 626 of FIGS. 6A, 6B, and 6C, respectively. The embodiments are not limited in this context.

FIG. 7B illustrates a second example of a command that may be representative of a T4 interface command 332 that SMS-SC 360 of FIG. 3 may send in various embodiments to report the results of a trigger recall procedure for device trigger 320. More particularly, FIG. 7B illustrates an example of a Device-Trigger-Recall-Answer command 710 such as may be representative of a newly defined command of an enhanced T4 interface Diameter protocol with which communications component 306 of FIG. 3 may be configured by enhanced T4 interface communications module 322 in some embodiments. In the example of FIG. 7B, Device-Trigger-Recall-Answer 710 comprises a Result-Code AVP 712 and stored trigger ID AVP 714, which may be the same as or similar to Result-Code AVP 702 and stored trigger ID AVP 704 of FIG. 7A, respectively. In various embodiments, Device-Trigger-Recall-Answer 710 also may comprise one or more other AVPs 716, examples of which may include, without limitation, the example previously mentioned with respect to other AVPs 606, 618, 626, and 708 of FIGS. 6A, 6B, 6C, and 7A, respectively. Unlike Device-Trigger-Answer 700 of FIG. 7A, Device-Trigger-Recall-Answer 710 may comprise a T4 interface Diameter protocol command specifically designated for use in reporting the results of device trigger recall procedures. The embodiments are not limited in this context.

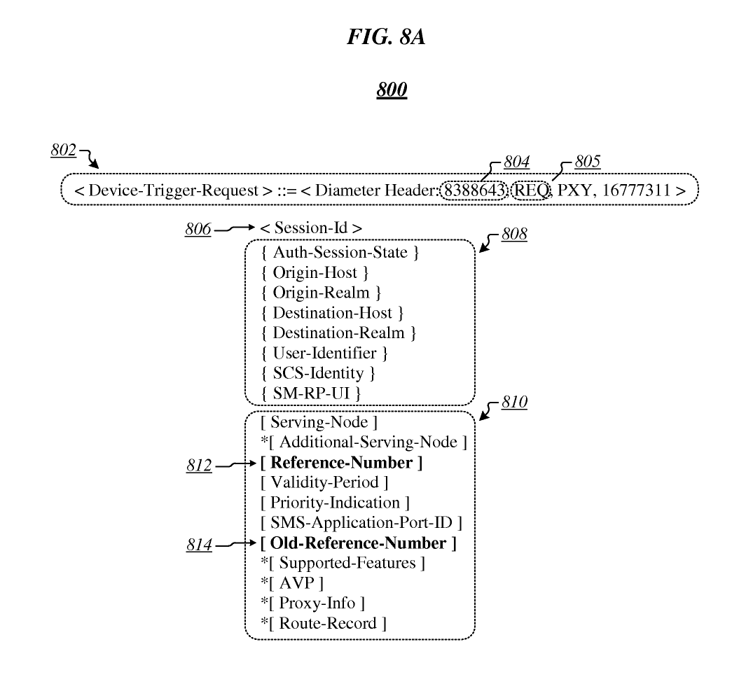

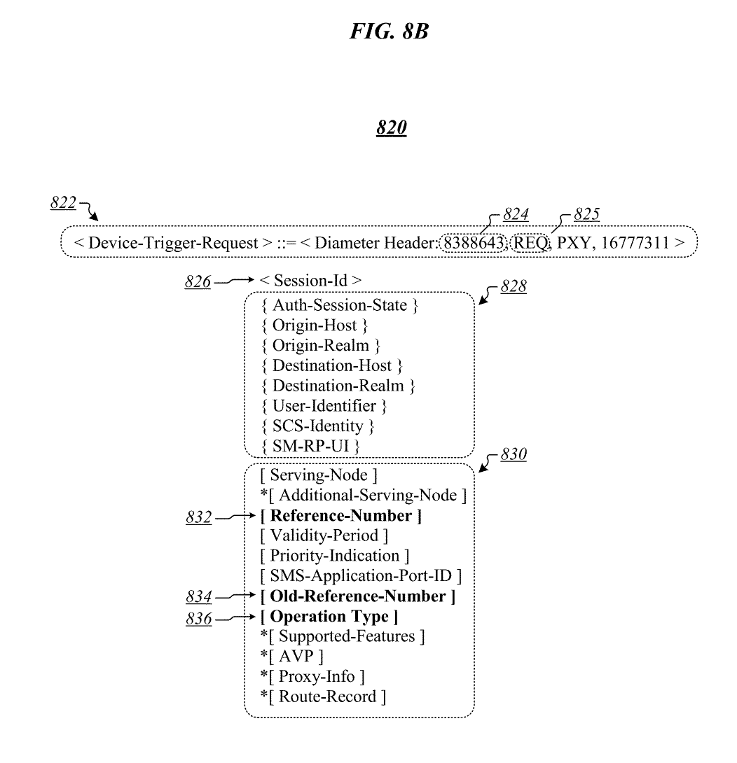

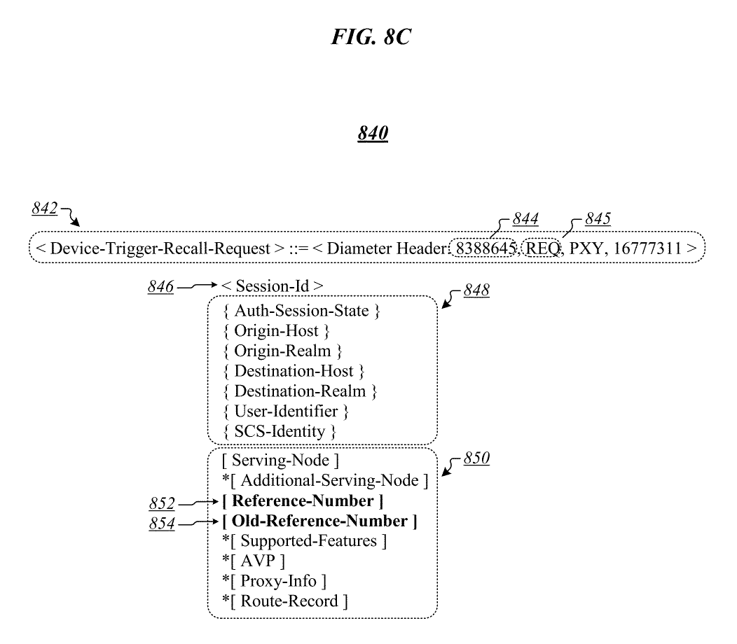

FIG. 8A illustrates a first example command message format, which may be representative of a T4 interface command 324 that communications component 306 of FIG. 3 may send in various embodiments. More particularly, FIG. 8A illustrates an example of a Diameter protocol command message format 800 that may be representative of Device-Trigger-Request 400 of FIG. 4A in some embodiments. As shown in FIG. 8A, Diameter protocol command message format 800 comprises a Diameter header 802. Diameter header 802 includes a Diameter header code 804, which contains a designated Diameter header code value for Device-Trigger commands. Diameter header 802 also includes an “R bit” 805, which when set—as indicated by the value “REQ” in Diameter header 802—indicates that the Diameter protocol command comprises a request. Collectively, the values of Diameter header code 804 and r-bit 805 indicate that Diameter protocol command message format 800 comprises a format for a Device-Trigger-Request command.

Diameter protocol command message format 800 also includes a plurality of AVPs. The plurality of AVPs in example Diameter protocol command message format 800 comprises a fixed Session-ID AVP 806, a set of required AVPs 808, and a set of optional AVPs 810. The set of required AVPs 808 in example Diameter protocol command message format 800 comprises an Auth-Session-State AVP, an Origin-Host AVP, an Origin-Realm AVP, a Destination-Host AVP, a Destination-Realm AVP, a User-Identifier AVP, an SCS-Identity AVP, and an SM-RP-UI AVP. Included among the set of optional AVPs 810 in example Diameter protocol command message format 800 are a Serving-Node AVP, an Additional-Serving-Node AVP, a Validity-Period AVP, a Priority-Indication AVP, an SMS-Application-Port ID AVP, a Supported-Features AVP, an AVP AVP, a Proxy-Info AVP, and a Route-Record AVP. Also comprised among the set of optional AVPs 810 in example Diameter protocol command message format 800 are a Reference-Number AVP 812 and an Old-Reference-Number AVP 814.

In various embodiments, Diameter protocol command message format 800 may comprise a format for Device-Trigger-Request 400 of FIG. 4A. In such embodiments, Reference-Number AVP 812 may comprise Reference-Number AVP 402 of FIG. 4A, and Old-Reference-Number AVP 814 may comprise Old-Reference-Number AVP 404 of FIG. 4A. The embodiments are not limited in this context.

FIG. 8B illustrates a second example command message format, which may be representative of a T4 interface command 324 that communications component 306 of FIG. 3 may send in various embodiments. More particularly, FIG. 8B illustrates an example of a Diameter protocol command message format 820 that may be representative of Device-Trigger-Request 410 of FIG. 4B and/or Device-Trigger-Request 500 of FIG. 5A in some embodiments. As shown in FIG. 8B, Diameter protocol command message format 820 comprises a Diameter header 822. Diameter header 822 includes a Diameter header code 824, which contains a designated Diameter header code value for Device-Trigger commands. Diameter header 822 also includes an “r-bit” 825, which when set—as indicated by the value “REQ” in Diameter header 822—indicates that the Diameter protocol command comprises a request. Collectively, the values of Diameter header code 824 and r-bit 825 indicate that Diameter protocol command message format 820 comprises a format for a Device-Trigger-Request command.

Diameter protocol command message format 820 also includes a plurality of AVPs. The plurality of AVPs in example Diameter protocol command message format 820 comprises a fixed Session-ID AVP 826, a set of required AVPs 828, and a set of optional AVPs 830. The set of required AVPs 828 in example Diameter protocol command message format 820 comprises an Auth-Session-State AVP, an Origin-Host AVP, an Origin-Realm AVP, a Destination-Host AVP, a Destination-Realm AVP, a User-Identifier AVP, an SCS-Identity AVP, and an SM-RP-UI AVP. Included among the set of optional AVPs 830 in example Diameter protocol command message format 820 are a Serving-Node AVP, an Additional-Serving-Node AVP, a Validity-Period AVP, a Priority-Indication AVP, an SMS-Application-Port ID AVP, a Supported-Features AVP, an AVP AVP, a Proxy-Info AVP, and a Route-Record AVP. Also comprised among the set of optional AVPs 830 in example Diameter protocol command message format 820 are a Reference-Number AVP 832, an Old-Reference-Number AVP 834, and an Operation Type AVP 836.

In various embodiments, Diameter protocol command message format 820 may comprise a format for Device-Trigger-Request 410 of FIG. 4B. In such embodiments, Reference-Number AVP 832 may comprise Reference-Number AVP 412 of FIG. 4B and Old-Reference-Number AVP 834 may comprise Old-Reference-Number AVP 414 of FIG. 4B. In such embodiments, Operation Type AVP 836 may comprise Operation Type AVP 416 of FIG. 4B, and may contain a value indicating that the Device-Trigger-Request 410 formatted in accordance with Diameter protocol command message format 820 is intended to initiate a trigger replacement procedure. In some embodiments, operation type AVP 836 may be referred by other names (e.g. Action Type, Trigger Type, Trigger Action etc.). The embodiments are not limited in this context.

In various embodiments, Diameter protocol command message format 820 may comprise a format for Device-Trigger-Request 500 of FIG. 5A. In such embodiments, one or both of Reference-Number AVP 832 and Old-Reference-Number AVP 834 may comprise Stored Trigger ID AVP 502 of FIG. 5A. In such embodiments, Operation Type AVP 836 may comprise Operation Type AVP 504 of FIG. 5A, and may contain a value indicating that the Device-Trigger-Request 500 formatted in accordance with Diameter protocol command message format 820 is intended to initiate a trigger recall procedure. The embodiments are not limited in this context.

FIG. 8C illustrates a third example command message format, which may be representative of a T4 interface command 324 that communications component 306 of FIG. 3 may send in various embodiments. More particularly, FIG. 8C illustrates an example of a Diameter protocol command message format 840 that may be representative of Device-Trigger-Recall-Request 510 of FIG. 5B in some embodiments. As shown in FIG. 8C, Diameter protocol command message format 840 comprises a Diameter header 842. Diameter header 842 includes a Diameter header code 844, which contains a designated Diameter header code value for Device-Trigger-Recall commands. Diameter header 842 also includes an “r-bit” 845, which when set—as indicated by the value “REQ” in Diameter header 842—indicates that the Diameter protocol command comprises a request. Collectively, the values of Diameter header code 844 and r-bit 845 indicate that Diameter protocol command message format 840 comprises a format for a Device-Trigger-Recall-Request command.

Diameter protocol command message format 840 also includes a plurality of AVPs. The plurality of AVPs in example Diameter protocol command message format 840 comprises a fixed Session-ID AVP 846, a set of required AVPs 848, and a set of optional AVPs 850. The set of required AVPs 848 in example Diameter protocol command message format 840 comprises an Auth-Session-State AVP, an Origin-Host AVP, an Origin-Realm AVP, a Destination-Host AVP, a Destination-Realm AVP, a User-Identifier AVP, and an SCS-Identity AVP. Included among the set of optional AVPs 850 in example Diameter protocol command message format 840 are a Serving-Node AVP, an Additional-Serving-Node AVP, a Supported-Features AVP, an AVP, a Proxy-Info AVP, and a Route-Record AVP. Also comprised among the set of optional AVPs 850 in example Diameter protocol command message format 840 are a Reference-Number AVP 852 and an Old-Reference-Number AVP 854.

In various embodiments, Diameter protocol command message format 840 may comprise a format for Device-Trigger-Recall-Request 510 of FIG. 5B. In such embodiments, one or both of Reference-Number AVP 852 and Old-Reference-Number AVP 854 may comprise Stored Trigger ID AVP 512 of FIG. 5B. The embodiments are not limited in this context.

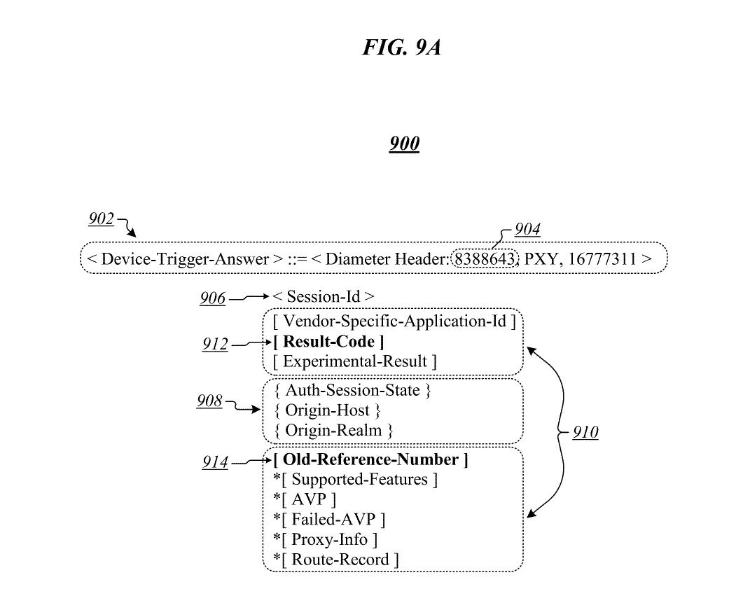

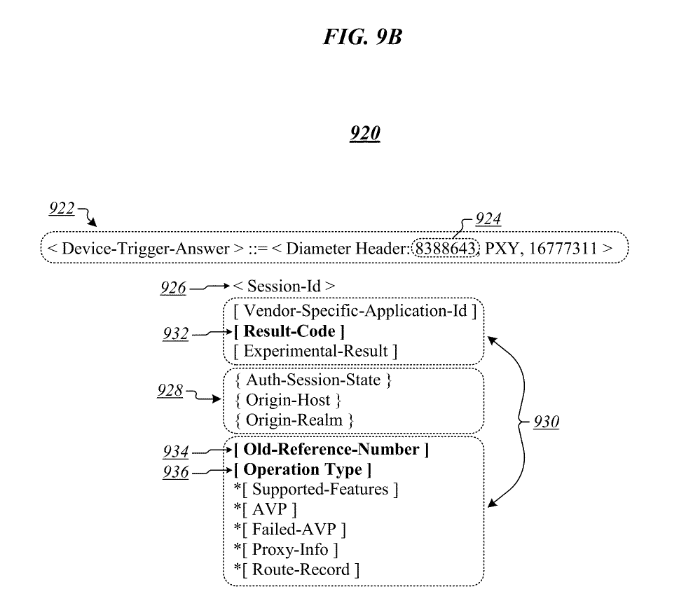

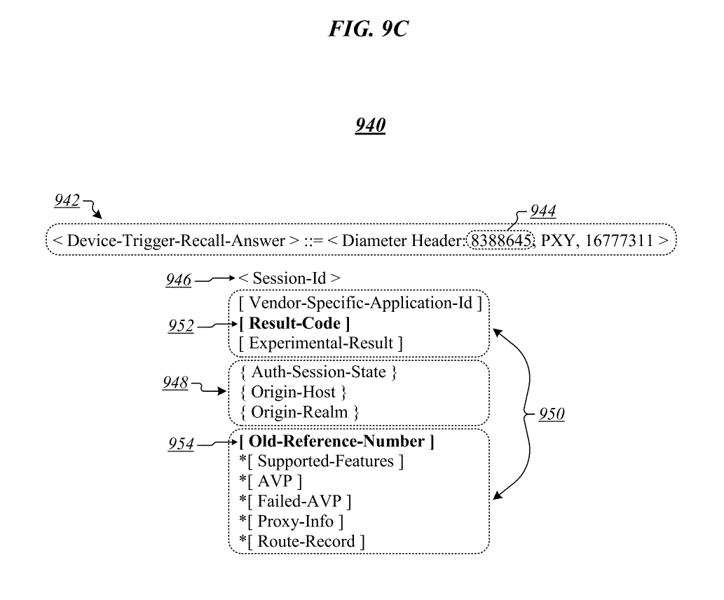

FIG. 9A illustrates a fourth example command message format, which may be representative of a T4 interface command 332 that communications component 306 of FIG. 3 may receive in various embodiments. More particularly, FIG. 9A illustrates an example of a Diameter protocol command message format 900 that may be representative of Device-Trigger-Answer 600 of FIG. 6A in some embodiments. As shown in FIG. 9A, Diameter protocol command message format 900 comprises a Diameter header 902. Diameter header 902 includes a Diameter header code 904, which contains a designated Diameter header code value for Device-Trigger commands. The absence of a value “REQ” in Diameter header 902 indicates that an R bit of Diameter header 902 is cleared, and thus that the Diameter protocol command comprises an answer rather than a request. Collectively, the value of Diameter header code 904 and the absence of the value “REQ” indicate that Diameter protocol command message format 900 comprises a format for a Device-Trigger-Answer command.

Diameter protocol command message format 900 also includes a plurality of AVPs. The plurality of AVPs in example Diameter protocol command message format 900 comprises a fixed Session-ID AVP 906, a set of required AVPs 908, and a set of optional AVPs 910. The set of required AVPs 908 in example Diameter protocol command message format 900 comprises an Auth-Session-State AVP, an Origin-Host AVP, and an Origin-Realm AVP. Included among the set of optional AVPs 910 in example Diameter protocol command message format 900 are a Vendor-Specific-Application-Id AVP, an Experimental-Result AVP, a Supported-Features AVP, an AVP AVP, a Failed-AVP AVP, a Proxy-Info AVP, and a Route-Record AVP. Also comprised among the set of optional AVPs 910 in example Diameter protocol command message format 900 are a Result-Code AVP 912 and an Old-Reference-Number AVP 914.

In various embodiments, Diameter protocol command message format 900 may comprise a format for Device-Trigger-Answer 600 of FIG. 6A. In such embodiments, Result-Code AVP 912 may comprise Result-Code AVP 602 of FIG. 6A and Old-Reference-Number AVP 914 may comprise Stored Trigger ID AVP 604 of FIG. 6A. The embodiments are not limited in this context.

FIG. 9B illustrates a fifth example command message format, which may be representative of a T4 interface command 332 that communications component 306 of FIG. 3 may receive in various embodiments. More particularly, FIG. 9B illustrates an example of a Diameter protocol command message format 920 that may be representative of Device-Trigger-Answer 610 of FIG. 6B and/or Device-Trigger-Answer 700 of FIG. 7A in some embodiments. As shown in FIG. 9B, Diameter protocol command message format 920 comprises a Diameter header 922. Diameter header 922 includes a Diameter header code 924, which contains a designated Diameter header code value for Device-Trigger commands. The absence of a value “REQ” in Diameter header 922 indicates that an R bit of Diameter header 922 is cleared, and thus that the Diameter protocol command comprises an answer rather than a request. Collectively, the value of Diameter header code 924 and the absence of the value “REQ” indicate that Diameter protocol command message format 920 comprises a format for a Device-Trigger-Answer command.

Diameter protocol command message format 920 also includes a plurality of AVPs. The plurality of AVPs in example Diameter protocol command message format 920 comprises a fixed Session-ID AVP 926, a set of required AVPs 928, and a set of optional AVPs 930. The set of required AVPs 928 in example Diameter protocol command message format 920 comprises an Auth-Session-State AVP, an Origin-Host AVP, and an Origin-Realm AVP. Included among the set of optional AVPs 930 in example Diameter protocol command message format 920 are a Vendor-Specific-Application-Id AVP, an Experimental-Result AVP, a Supported-Features AVP, an AVP AVP, a Failed-AVP AVP, a Proxy-Info AVP, and a Route-Record AVP. Also comprised among the set of optional AVPs 930 in example Diameter protocol command message format 920 are a Result-Code AVP 932, an Old-Reference-Number AVP 934, and an Operation Type AVP 936.

In various embodiments, Diameter protocol command message format 920 may comprise a format for Device-Trigger-Answer 610 of FIG. 6B. In such embodiments, Result-Code AVP 932 may comprise Result-Code AVP 612 of FIG. 6B and Old-Reference-Number AVP 934 may comprise Stored Trigger ID AVP 614 of FIG. 6B. In such embodiments, Operation Type AVP 936 may comprise Operation Type AVP 616 of FIG. 6B, and may contain a value indicating that the Device-Trigger-Answer 610 formatted in accordance with Diameter protocol command message format 920 is intended to report the results of a trigger replacement procedure. In some embodiments, operation type AVP 936 may be referred by other names (e.g. Action Type, Trigger Type, Trigger Action etc.). The embodiments are not limited in this context.

In various embodiments, Diameter protocol command message format 920 may comprise a format for Device-Trigger-Answer 700 of FIG. 7A. In such embodiments, Result-Code AVP 932 may comprise Result-Code AVP 702 of FIG. 7A and Old-Reference-Number AVP 934 may comprise Stored Trigger ID AVP 704 of FIG. 7A. In such embodiments, Operation Type AVP 936 may comprise Operation Type AVP 706 of FIG. 7A, and may contain a value indicating that the Device-Trigger-Answer 700 formatted in accordance with Diameter protocol command message format 920 is intended to report the results of a trigger recall procedure. The embodiments are not limited in this context.

FIG. 9C illustrates a sixth example command message format, which may be representative of a T4 interface command 332 that communications component 306 of FIG. 3 may receive in various embodiments. More particularly, FIG. 9C illustrates an example of a Diameter protocol command message format 940 that may be representative of Device-Trigger-Recall-Answer 710 of FIG. 7B in some embodiments. As shown in FIG. 9C, Diameter protocol command message format 940 comprises a Diameter header 942. Diameter header 942 includes a Diameter header code 944, which contains a designated Diameter header code value for Device-Trigger-Recall commands. The absence of a value “REQ” in Diameter header 942 indicates that an R bit of Diameter header 942 is cleared, and thus that the Diameter protocol command comprises an answer rather than a request. Collectively, the value of Diameter header code 944 and the absence of the value “REQ” indicate that Diameter protocol command message format 940 comprises a format for a Device-Trigger-Recall-Answer command.

Diameter protocol command message format 940 also includes a plurality of AVPs. The plurality of AVPs in example Diameter protocol command message format 940 comprises a fixed Session-ID AVP 946, a set of required AVPs 948, and a set of optional AVPs 950. The set of required AVPs 948 in example Diameter protocol command message format 940 comprises an Auth-Session-State AVP, an Origin-Host AVP, and an Origin-Realm AVP. Included among the set of optional AVPs 950 in example Diameter protocol command message format 940 are a Vendor-Specific-Application-Id AVP, an Experimental-Result AVP, a Supported-Features AVP, an AVP AVP, a Failed-AVP AVP, a Proxy-Info AVP, and a Route-Record AVP. Also comprised among the set of optional AVPs 950 in example Diameter protocol command message format 940 are a Result-Code AVP 952 and an Old-Reference-Number AVP 954.

In various embodiments, Diameter protocol command message format 940 may comprise a format for Device-Trigger-Recall-Answer 710 of FIG. 7B. In such embodiments, Result-Code AVP 952 may comprise Result-Code AVP 712 of FIG. 7B and Old-Reference-Number AVP 954 may comprise Stored Trigger ID AVP 714 of FIG. 7B. The embodiments are not limited in this context.

Returning to FIG. 3, in some embodiments, communications component 306 may be operative to send a trigger adjustment answer 338 to SCS 350 based on the T4 interface command 332 that it receives from SMS-SC 360. In various embodiments, communications component 306 may be operative to send trigger adjustment answer 338 to SCS 350 via Tsp interface connection 312. In some embodiments, trigger adjustment answer 338 may comprise a Diameter protocol command for a Tsp interface Diameter application. In various embodiments, trigger adjustment answer 338 may comprise a Device-Action-Answer (DAA) command. In some embodiments, trigger adjustment answer 338 may comprise the result 334 received in the T4 interface command 332. In various embodiments, trigger adjustment answer 338 may also comprise the stored trigger ID 314 and/or the operation ID 316 received in the trigger adjustment request 310 to which it constitutes a response. The embodiments are not limited in this context.

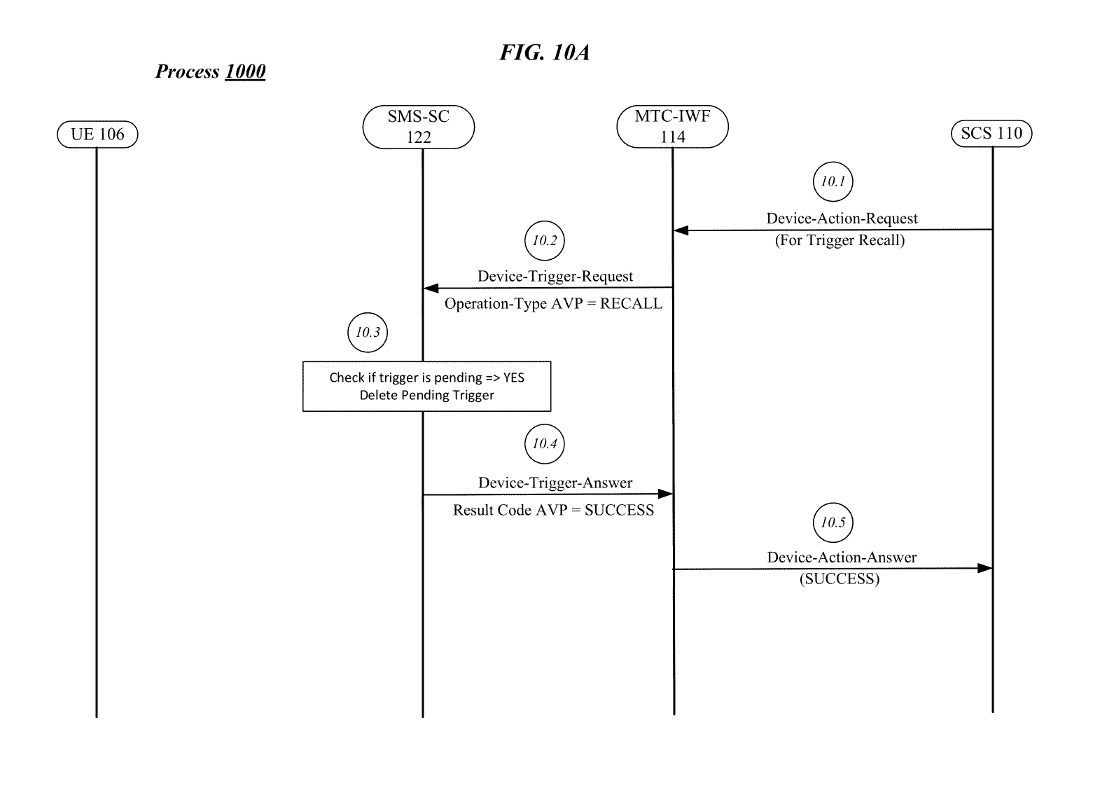

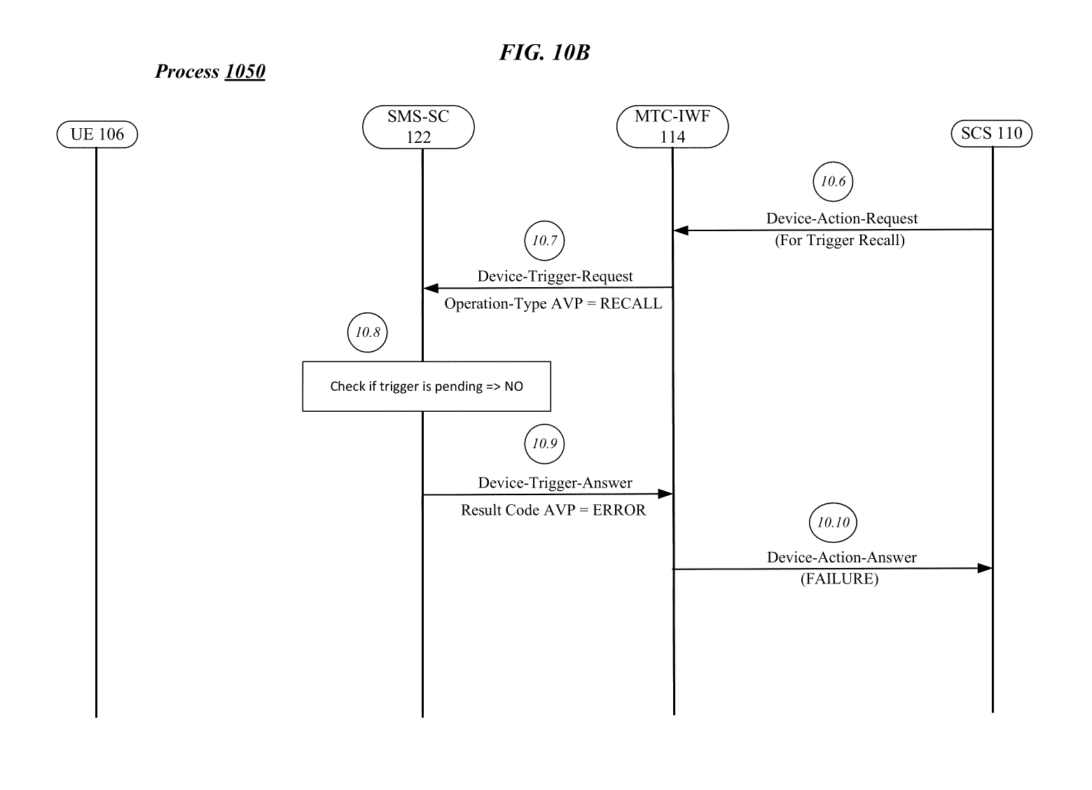

FIG. 10A illustrates a first example process 1000, which may be representative of a successful device trigger recall request. Example process 1000 depicts elements of operating environments 100 and 200 of FIGS. 1 and 2, including UE 106, SCS 110, MTC-IWF 114, and SMS-SC 122. However, example process 1000 is not limited to implementations using such elements.

As shown in FIG. 10A, example process 1000 comprises sub-processes 10.1 to 10.5. During sub-process 10.1, SCS 110 may send a Device-Action-Request command to MTC-IWF 114 to request a trigger recall. During sub-process 10.2, MTC-IWF 114 may send a Device-Trigger-Request command to SMS-SC 122 to request the trigger recall. The MTC-IWF 114 shall include the Old Trigger Reference Number in the Device-Trigger-Request command if it has received the Old Trigger Reference Number from SCS 110 over a Tsp interface. The Device-Trigger-Request command may identify a previously submitted device trigger using the Old Trigger Reference Number, and may include an Operation-Type AVP that comprises a specific value set to RECALL to indicate that the Device-Trigger-Request command is intended to remove a pending trigger. In some embodiments, the Operation-Type AVP may be referred by other names (e.g. Action Type, Trigger Type, Trigger Action etc.) In some embodiments, the Device-Trigger-Request command sent during sub-process 10.2 may be the same as or similar to Device-Trigger-Request 500 of FIG. 5A and/or may comprise a format that is the same as or similar to Diameter protocol command message format 820 of FIG. 8B. The embodiments are not limited in this context.

During sub-process 10.3, SMS-SC 122 may determine whether the trigger message corresponding to Reference-Number is pending. In response to a determination that the trigger message is pending, SMS-SC 122 may delete the old trigger message. During sub-process 10.4, SMS-SC 122 may send a Device-Trigger-Answer command to MTC-IWF 114 to report the results of the Device-Trigger-Request command. The Device-Trigger-Answer command includes a Result Code AVP that comprises a value set to DIAMETER_SUCCESS indicating that the trigger has been successfully recalled. In some embodiments, SMS-SC 122 may not initiate a device trigger reporting to the device trigger of Old Reference Number. In some embodiments, the Device-Trigger-Answer command sent during sub-process 10.4 may be the same as or similar to Device-Trigger-Answer 700 of FIG. 7A and/or may comprise a format that is the same as or similar to Diameter protocol command message format 920 of FIG. 9B. During sub-process 10.5, MTC-IWF 114 may send a Device-Action-Answer command to SCS 110 in order to notify SCS 110 that the stored trigger has been successfully recalled. The embodiments are not limited in this context.

FIG. 10B illustrates a second example process 1050, which may be representative of a failed device trigger recall request. Example process 1050 depicts elements of operating environments 100 and 200 of FIGS. 1 and 2, including UE 106, SCS 110, MTC-IWF 114, and SMS-SC 122. However, example process 1050 is not limited to implementations using such elements.

As shown in FIG. 10B, example process 1050 comprises sub-processes 10.6 to 10.10. During sub-process 10.6, SCS 110 may send a Device-Action-Request command to MTC-IWF 114 to request a trigger recall. During sub-process 10.7, MTC-IWF 114 may send a Device-Trigger-Request command to SMS-SC 122 to request the trigger recall. The MTC-IWF 114 shall include the Old Trigger Reference Number in the Device-Trigger-Request command if it has received the Old Trigger Reference Number from SCS 110 over a Tsp interface. The Device-Trigger-Request command may identify a previously submitted device trigger, and may include an Operation-Type AVP that comprises a value set to RECALL to indicate that the Device-Trigger-Request command comprises a trigger recall request. In some embodiments, the Operation-Type AVP may be referred by other names (e.g. Action Type, Trigger Type, Trigger Action etc.). In some embodiments, the Device-Trigger-Request command sent during sub-process 10.7 may be the same as or similar to Device-Trigger-Request 500 of FIG. 5A and/or may comprise a format that is the same as or similar to Diameter protocol command message format 820 of FIG. 8B. The embodiments are not limited in this context.

During sub-process 10.8, SMS-SC 122 may determine that the previously submitted trigger identified by the Device-Trigger-Request command is no longer pending. During sub-process 10.9, SMS-SC 122 may send a Device-Trigger-Answer command to MTC-IWF 114 to report the results of the Device-Trigger-Request command. The Device-Trigger-Answer command may include a Result Code AVP that comprises a value indicating that an error has been encountered and the trigger has not been successfully recalled. In some embodiments, the Device-Trigger-Answer command sent during sub-process 10.9 may be the same as or similar to Device-Trigger-Answer 700 of FIG. 7A and/or may comprise a format that is the same as or similar to Diameter protocol command message format 920 of FIG. 9B. During sub-process 10.10, MTC-IWF 114 may send a Device-Action-Answer command to SCS 110 in order to notify SCS 110 that the stored trigger has not been successfully recalled. The embodiments are not limited in this context.

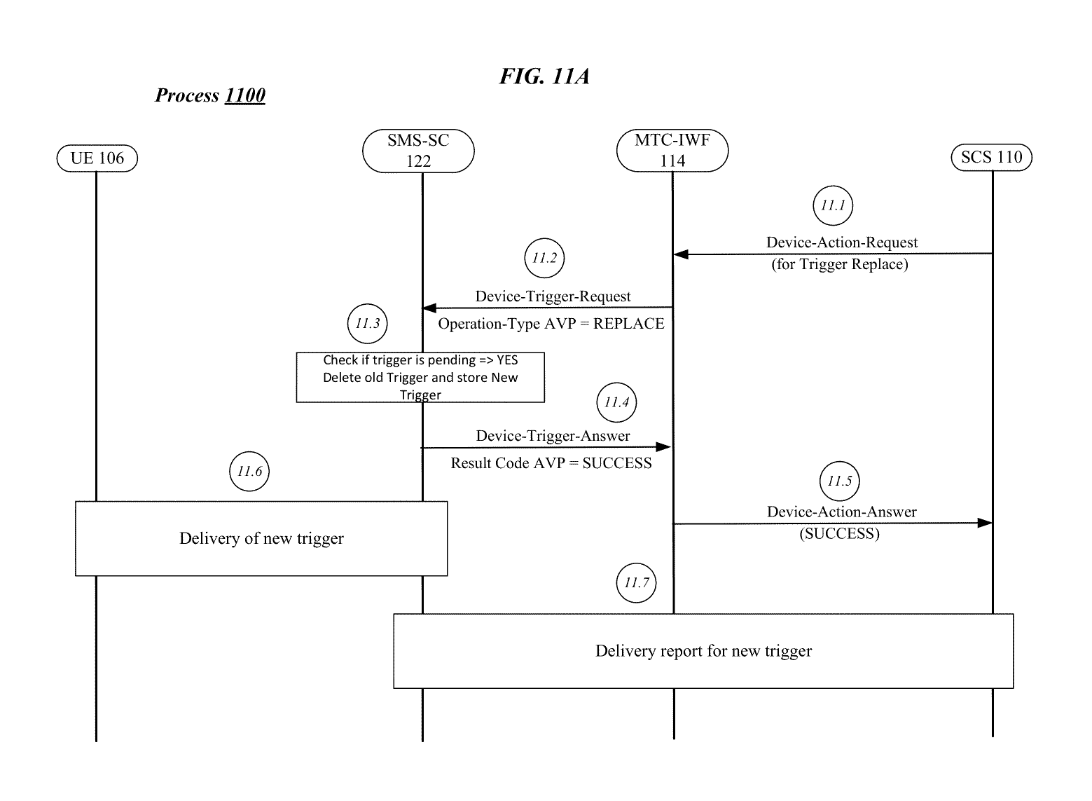

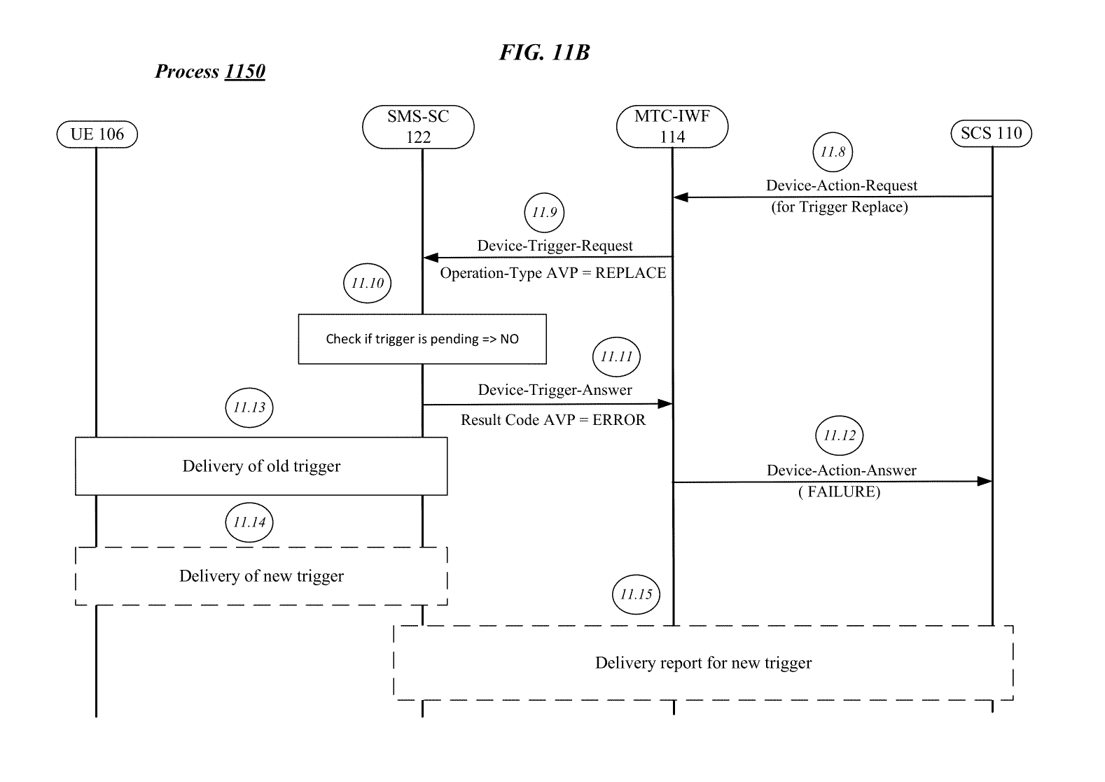

FIG. 11A illustrates a third example process 1100, which may be representative of a successful device trigger replace request. Example process 1100 depicts elements of operating environments 100 and 200 of FIGS. 1 and 2, including UE 106, SCS 110, MTC-IWF 114, and SMS-SC 122. However, example process 1100 is not limited to implementations using such elements.

As shown in FIG. 11A, example process 1100 comprises sub-processes 11.1 to 11.7. During sub-process 11.1, SCS 110 may send a Device-Action-Request command to MTC-IWF 114 to request a trigger replacement. During sub-process 11.2, MTC-IWF 114 may send a Device-Trigger-Request command to SMS-SC 122 to request the trigger replacement. The MTC-IWF 114 shall include the Old Trigger Reference Number in the Device-Trigger-Request command if it has received the Old Trigger Reference Number from SCS 110 over a Tsp interface. The Device-Trigger-Request command may identify a previously submitted device trigger and a new device trigger, and may include an Operation-Type AVP that comprises a value set to REPLACE to indicate that the Device-Trigger-Request command comprises a trigger replacement request. In some embodiments, the Operation-Type AVP may be referred by other names (e.g. Action Type, Trigger Type, Trigger Action etc.). In some embodiments, the Device-Trigger-Request command sent during sub-process 11.2 may be the same as or similar to Device-Trigger-Request 410 of FIG. 4B and/or may comprise a format that is the same as or similar to Diameter protocol command message format 820 of FIG. 8B. The embodiments are not limited in this context.

During sub-process 11.3, SMS-SC 122 may determine whether the trigger message corresponding to Old-Reference-Number is pending. In response to a determination that the trigger message is pending, SMS-SC 122 shall delete the old trigger message, and store the new trigger message received from MTC-IWF 114. During sub-process 11.4, SMS-SC 122 may send a Device-Trigger-Answer command to MTC-IWF 114 to report the results of the Device-Trigger-Request command. The Device-Trigger-Answer command includes a Result Code AVP that comprises a value set to DIAMETER_SUCESS to indicate that the previously submitted trigger has been successfully replaced. The Device-Trigger-Answer may also include an Old-Reference-Number for the old trigger message. In some embodiments, SMS-SC 122 may not be required to initiate a device trigger reporting to the device trigger of Old-Reference-Number. In some embodiments, the Device-Trigger-Answer command sent during sub-process 11.4 may be the same as or similar to Device-Trigger-Answer 610 of FIG. 6B and/or may comprise a format that is the same as or similar to Diameter protocol command message format 920 of FIG. 9B. During sub-process 11.5, MTC-IWF 114 may send a Device-Action-Answer command to SCS 110 in order to notify SCS 110 that the stored trigger has been successfully replaced. During sub-process 11.6, SMS-SC 122 may deliver the new trigger to UE 106. During sub-process 11.7, SMS-SC 122 may report to SCS 110, via MTC-IWF 114, that the new trigger has been delivered to UE 106. The embodiments are not limited in this context.

FIG. 11B illustrates a fourth example process 1150, which may be representative of a failed device trigger replace request. Example process 1150 depicts elements of operating environments 100 and 200 of FIGS. 1 and 2, including UE 106, SCS 110, MTC-IWF 114, and SMS-SC 122. However, example process 1150 is not limited to implementations using such elements.

As shown in FIG. 11B, example process 1150 comprises sub-processes 11.8 to 11.15. During sub-process 11.8, SCS 110 may send a Device-Action-Request command to MTC-IWF 114 to request a trigger replacement. During sub-process 11.9, MTC-IWF 114 may send a Device-Trigger-Request command to SMS-SC 122 to request the trigger replacement. The MTC-IWF 114 shall include the Old Trigger Reference Number in the Device-Trigger-Request command if it has received the Old Trigger Reference Number from SCS 110 over a Tsp interface. The Device-Trigger-Request command may identify a previously submitted device trigger and a new device trigger, and may include an Operation-Type AVP that comprises a value set to REPLACE to indicate that the Device-Trigger-Request command comprises a trigger replacement request. In some embodiments, the Operation-Type AVP may be referred by other names (e.g. Action Type, Trigger Type, Trigger Action etc.). In some embodiments, the Device-Trigger-Request command sent during sub-process 11.9 may be the same as or similar to Device-Trigger-Request 410 of FIG. 4B and/or may comprise a format that is the same as or similar to Diameter protocol command message format 820 of FIG. 8B. The embodiments are not limited in this context.

During sub-process 11.10, SMS-SC 122 may store the new device trigger but may determine that the previously submitted trigger identified by the Device-Trigger-Request command is no longer pending. During sub-process 11.11, SMS-SC 122 may send a Device-Trigger-Answer command to MTC-IWF 114 to report the results of the Device-Trigger-Request command. The Device-Trigger-Answer command may include a Result Code AVP that comprises a value indicating that an error has been encountered and that the previously submitted trigger has not been determined to be pending at SMS-SC 122. In some embodiments, The Device-Trigger-Answer command may include a Result Code AVP that comprises a value set to DIAMETER_ERROR_TRIGGER_REPLACE_FAILURE to indicate that an error has been encountered and trigger replace has failed. In some embodiments, the Device-Trigger-Answer command sent during sub-process 11.11 may be the same as or similar to Device-Trigger-Answer 610 of FIG. 6B and/or may comprise a format that is the same as or similar to Diameter protocol command message format 920 of FIG. 9B. During sub-process 11.12, MTC-IWF 114 may send a Device-Action-Answer command to SCS 110 in order to notify SCS 110 that the stored trigger has not been successfully replaced. During sub-process 11.13, the previously submitted trigger may be delivered to UE 106. During sub-process 11.14, the new trigger may be delivered to UE 106. During sub-process 11.15, SMS-SC 122 may report to SCS 110, via MTC-IWF 114, that the new trigger has been delivered to UE 106. In some embodiments, SMS-SC 122 may not store the new device trigger during sub-process 11.10, and process 1150 may end following sub-process 11.13. The embodiments are not limited in this context.

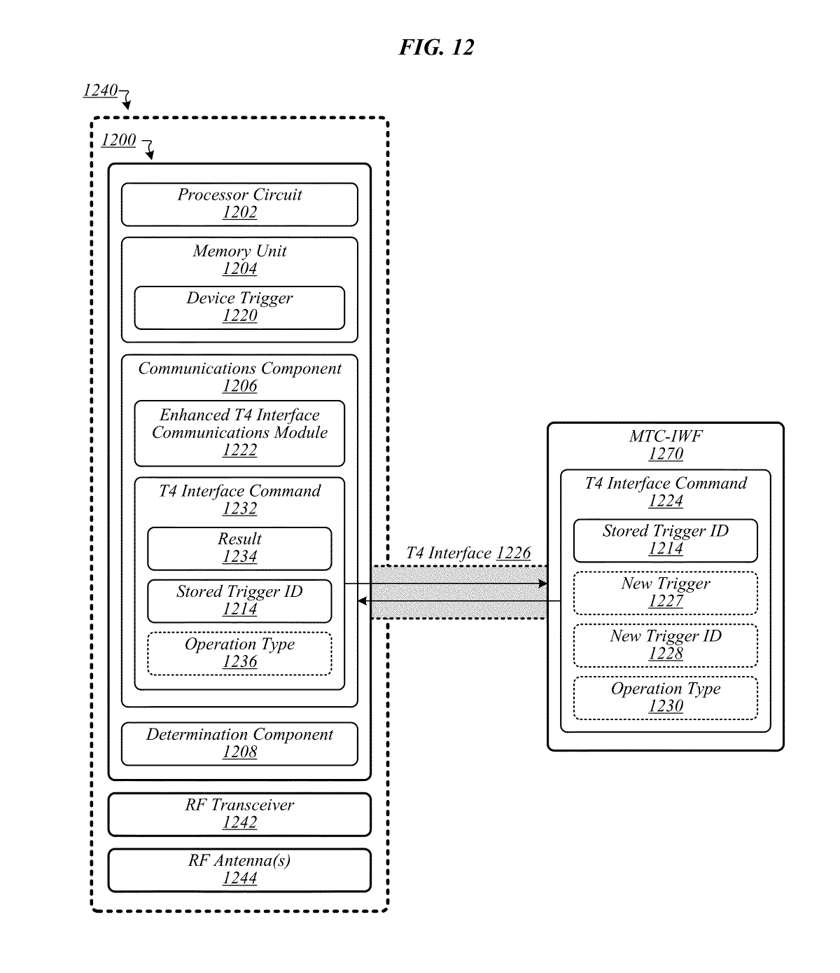

FIG. 12 illustrates a block diagram of an apparatus 1200. Apparatus 1200 may be representative of an SMS-SC/GMSC/IWMSC node such as may be configured in some embodiments to communicate over a T4 interface connection according to trigger replacement and recall support techniques disclosed herein. Apparatus 1200 may be representative of SMS-SC/GMSC/IWMSC 122 of FIGS. 1 and 2 and/or SMS-SC 360 of FIG. 3 in various embodiments. As shown in FIG. 12, apparatus 1200 comprises multiple elements including a processor circuit 1202, a memory unit 1204, a communications component 1206, and a determination component 1208. The embodiments, however, are not limited to the type, number, or arrangement of elements shown in this figure.

In some embodiments, apparatus 1200 may comprise processor circuit 1202. Processor circuit 1202 may be implemented using any processor or logic device. Examples of processor circuit 1202 may include, without limitation, any of the examples previously presented with respect to processor circuit 302 of FIG. 3. The embodiments are not limited in this context.

In various embodiments, apparatus 1200 may comprise or be arranged to communicatively couple with a memory unit 1204. Memory unit 1204 may be implemented using any machine-readable or computer-readable media capable of storing data, including both volatile and non-volatile memory. Examples of memory unit 1204 may include, without limitation, any of the examples previously presented with respect to memory unit 304 of FIG. 3. It is worthy of note that some portion or all of memory unit 1204 may be included on the same integrated circuit as processor circuit 1202, or alternatively some portion or all of memory unit 1204 may be disposed on an integrated circuit or other medium, for example a hard disk drive, that is external to the integrated circuit of processor circuit 1202. Although memory unit 1204 is comprised within apparatus 1200 in FIG. 12, memory unit 1204 may be external to apparatus 1200 in some embodiments. The embodiments are not limited in this context.

In some embodiments, apparatus 1200 may comprise a communications component 1206. Communications component 1206 may comprise logic, circuitry, and/or instructions operative to send messages to one or more remote devices and/or to receive messages from one or more remote devices. In various embodiments, communications component 1206 may be operative to send and/or receive messages over one or more wired connections, one or more wireless connections, or a combination of both. In some embodiments, communications component 1206 may additionally comprise logic, circuitry, and/or instructions operative to perform various operations in support of such communications. Examples of such operations may include selection of transmission and/or reception parameters and/or timing, packet and/or protocol data unit (PDU) construction and/or deconstruction, encoding and/or decoding, error detection, and/or error correction. The embodiments are not limited to these examples.

In various embodiments, apparatus 1200 may comprise a determination component 1208. Determination component 1208 may comprise logic, circuitry, and/or instructions operative to perform various types of determinations and/or decisions in support of MTC operations performed by apparatus 1200. In some embodiments, determination component 1208 may be operative to perform one or more determinations and/or decisions in support of trigger management operations on the part of apparatus 1200 and/or one or more external nodes. The embodiments are not limited in this context.

FIG. 12 also illustrates a block diagram of a system 1240. System 1240 may comprise any of the aforementioned elements of apparatus 1200. System 1240 may further comprise an RF transceiver 1242. RF transceiver 1242 may comprise one or more radios capable of transmitting and receiving signals using various suitable wireless communications techniques. Such techniques may involve communications across one or more wireless networks. Examples of such wireless networks may include, without limitation, any of the examples previously presented with respect to RF transceiver 342 of FIG. 3. In communicating across such networks, RF transceiver 1242 may operate in accordance with one or more applicable standards in any version. The embodiments are not limited in this context.

In various embodiments, system 1240 may comprise one or more RF antennas 1244. Examples of any particular RF antenna 1244 may include, without limitation, any of the examples previously presented with respect to RF antenna(s) 344 of FIG. 3. In some embodiments, RF transceiver 1242 may be operative to send and/or receive messages and/or data using one or more RF antennas 1244. The embodiments are not limited in this context.

During general operation of apparatus 1200 and/or system 1240, communications component 1206 may be operative to receive a T4 interface command 1224 from an MTC-IWF node 1270. In various embodiments, MTC-IWF node 1270 may be the same as or similar to MTC-IWF 114 node of FIGS. 1 and 2 and/or apparatus 300 and/or system 340 of FIG. 3. In some embodiments, communications component 1206 may be operative to receive T4 interface command 1224 from MTC-IWF node 1270 via T4 interface connection 1226. In various embodiments, T4 interface connection 1226 may be the same as or similar to T4 interface connection 120 of FIGS. 1 and 2 and/or T4 interface connection 326 of FIG. 3. The embodiments are not limited in this context.

In some embodiments, MTC-IWF node 1270 may be operative to send T4 interface command 1224 to apparatus 1200 and/or system 1240 in order to initiate a trigger adjustment procedure for a previously stored device trigger. For example, in various embodiments, MTC-IWF 1270 may send T4 interface command 1224 to apparatus 1200 and/or system 1240 in order to initiate a trigger adjustment procedure for a device trigger 1220 that has previously been stored in memory unit 1204. In some embodiments, T4 interface command 1224 may comprise a stored trigger ID 1214. In various embodiments, stored trigger ID 1214 may comprise an identifier associated with the previously stored trigger that is to be subject to the trigger adjustment procedure. The embodiments are not limited in this context.

In some embodiments, communications component 1206 may comprise an enhanced T4 interface communications module 1222. Enhanced T4 interface communications module 1222 may comprise logic, circuitry, and/or instructions via which communications component 1206 is configured to communicate according to an enhanced T4 interface communications protocol that enables the conveyance of trigger replacement and/or recall requests, and/or acknowledgments thereof, over T4 interface connections. In various embodiments, T4 interface command 1224 may comprise a Diameter protocol command for a T4 interface Diameter application corresponding to the enhanced T4 interface communications protocol. In some such embodiments, stored trigger ID 1214 may comprise an AVP of the T4 interface Diameter protocol command, such as a Reference-Number AVP or an Old-Reference-Number AVP. In various embodiments, determination component 1208 may be operative to perform a trigger adjustment procedure for device trigger 1220 in response to receipt of T4 interface command 1224 from MTC-IWF node 1270. In some embodiments, determination component 1208 may be operative to determine whether the trigger adjustment procedure should comprise a trigger replacement procedure or a trigger recall procedure based on the type and/or contents of T4 interface command 1224.

In various embodiments, determination component 1208 may elect to perform a trigger replacement procedure in response to a determination that T4 interface command 1224 comprises a command of a type designated specifically for use in initiating trigger replacement. For example, determination component 1208 may elect to perform a trigger replacement procedure in response to a determination that T4 interface command 1224 comprises a Device-Trigger-Replace-Request command such as Device-Trigger-Replace-Request 420 of FIG. 4C. In some embodiments, determination component 1208 may elect to perform a trigger replacement procedure in response to a determination that values comprised in one or more fields of T4 interface command 1224 indicate that T4 interface command 1224 is intended to initiate trigger replacement. For example, determination component 1208 may elect to perform a trigger replacement procedure in response to a determination that T4 interface command 1224 comprises a Device-Trigger-Request, such as Device-Trigger-Request 400 of FIG. 4A, that contains both a Reference-Number AVP and an Old-Reference-Number AVP. In another example, determination component 1208 may elect to perform a trigger replacement procedure in response to a determination that T4 interface command 1224 comprises a Device-Trigger-Request, such as Device-Trigger-Request 410 of FIG. 4B, in which an operation type AVP contains a value indicating that the Device-Trigger-Request is intended to initiate trigger replacement. The embodiments are not limited to these examples.

In various embodiments, determination component 1208 may elect to perform a trigger recall procedure in response to a determination that T4 interface command 1224 comprises a command of a type designated specifically for use in initiating trigger recall. For example, determination component 1208 may elect to perform a trigger recall procedure in response to a determination that T4 interface command 1224 comprises a Device-Trigger-Recall-Request command such as Device-Trigger-Recall-Request 510 of FIG. 5B. In some embodiments, determination component 1208 may elect to perform a trigger recall procedure in response to a determination that values comprised in one or more fields of T4 interface command 1224 indicate that T4 interface command 1224 is intended to initiate trigger recall. For example, determination component 1208 may elect to perform a trigger recall procedure in response to a determination that T4 interface command 1224 comprises a Device-Trigger-Request, such as Device-Trigger-Request 500 of FIG. 5A, in which an operation type field 1230 contains a value indicating that the Device-Trigger-Request is intended to initiate trigger recall. The embodiments are not limited to these examples.

In various embodiments, in order to perform either a trigger replacement procedure or a trigger recall procedure, determination component 1208 may begin by identifying the device trigger to be replaced or recalled and determining whether that device trigger is still pending. In some embodiments, determination component 1208 may identify the device trigger to be replaced or recalled based on the stored trigger ID 1214 in T4 interface command 1224. In various embodiments, for example, determination component 1208 may identify device trigger 1220 as the device trigger to be replaced or recalled based on stored trigger ID 1214, and may then determine whether device trigger 1220 is still pending. In some embodiments, if the device trigger to be replaced or recalled has already been delivered to the destination UE and is thus no longer pending, determination component 1208 may be operative to determine that the trigger replacement or recall procedure results in a trigger replacement or recall failure. In various embodiments, if the device trigger to be replaced or recalled is still pending, determination component 1208 may proceed with attempting to replace or recall that device trigger.

In some embodiments, in order to recall a pending device trigger, determination component 1208 may be operative to delete that pending device trigger. For example, in various embodiments, determination component 1208 may be operative to recall device trigger 1220 by deleting it from memory unit 1204. In some embodiments, in order to replace a pending device trigger, determination component 1208 may be operative to delete the pending device trigger and store a new device trigger for subsequent delivery to the same destination UE. For example, in various embodiments, determination component 1208 may be operative to replace device trigger 1220 by deleting it from memory unit 1204 and storing within memory unit 1204 a new trigger 1227 received in T4 interface command 1224. In some embodiments, T4 interface command 1224 may contain the new trigger 1227 and a new trigger ID 1228 comprising an identifier associated with the new trigger 1227. It is worthy of note that due to other factors in various embodiments, it may be possible for trigger replacement or recall to fail even when device trigger 1220 is still pending upon receipt of T4 interface command 1224. The embodiments are not limited in this context.

In some embodiments, communications component 1206 may be operative to send a T4 interface command 1232 to MTC-IWF 1270 over T4 interface connection 1226 in order to report the results of a trigger adjustment procedure initiated via T4 interface command 1224. In various embodiments, T4 interface command 1232 may comprise a result field 1234 that contains information describing the results of the trigger adjustment procedure initiated via T4 interface command 1224. In some embodiments, T4 interface command 1232 may also comprise the stored trigger ID 1214 of the device trigger 1220 associated with that trigger adjustment procedure. In various embodiments, T4 interface command 1232 may comprise a Diameter protocol command for a T4 interface Diameter application corresponding to the enhanced T4 interface communications protocol with which enhanced T4 interface communications module 1222 configures communications component 1206.

In some embodiments, communications component 1206 may be operative to determine a format for T4 interface command 1232 based on the type of trigger adjustment procedure initiated via T4 interface command 1224. In various embodiments, determining the format for T4 interface command 1224 may involve determining a type of command that T4 interface command 324 is to comprise, determining what fields T4 interface command 324 is to include, and/or determining values that one or more such fields are to contain. In some embodiments, T4 interface command 1232 may include an operation type field 1236 comprising a value that indicates that T4 interface command 1232 constitutes a report of the results of a trigger replacement or recall procedure. In various embodiments, T4 interface command 1232 may comprise a legacy T4 interface Diameter protocol command adapted with an enhanced format that makes it suitable for use in reporting the results of the trigger adjustment procedure initiated via T4 interface command 1224. In some other embodiments, T4 interface command 1232 may be of a new type that the enhanced T4 interface communications protocol defines for use in reporting the results of trigger adjustment procedures of the type corresponding to T4 interface command 1224. Examples of T4 interface command 1232 in various embodiments may include any of the example commands depicted in FIGS. 6A-6C and 7A-7B. The embodiments are not limited to these examples.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

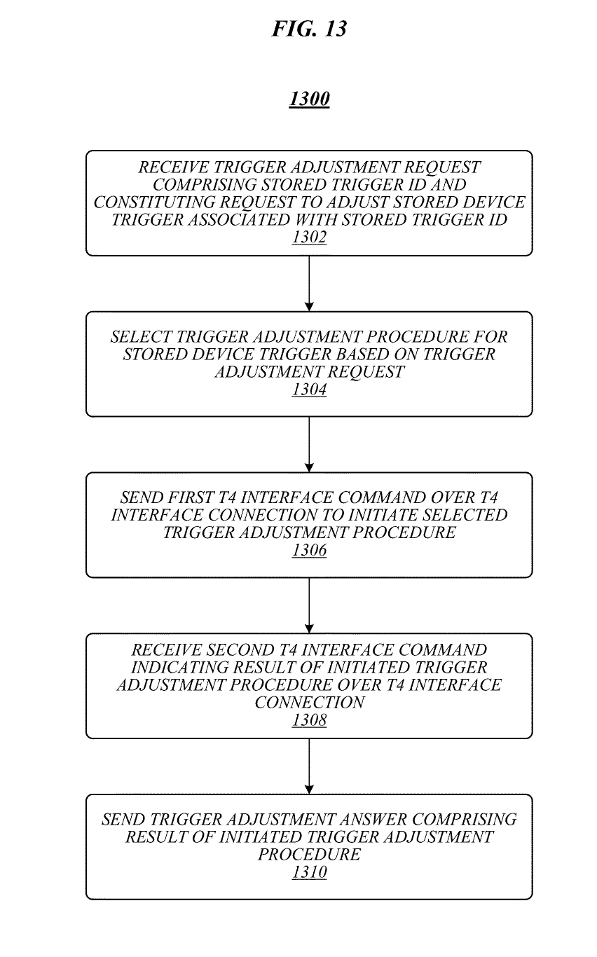

FIG. 13 illustrates a logic flow 1300 such as may be representative of some embodiments. For example, logic flow 1300 may be representative of operations that may be performed in various embodiments by one or more of MTC-IWF node 114 of FIGS. 1 and/or 2, apparatus 300 and/or system 340 of FIG. 3, and MTC-IWF node 770 of FIG. 7. As shown in logic flow 1300, a trigger adjustment request may be received at 1302 that comprises a stored trigger ID and that constitutes a request to adjust a stored device trigger associated with the stored trigger ID. For example, communications component 306 of FIG. 3 may be operative to receive a trigger adjustment request 310 that comprises a stored trigger ID 314 and that constitutes a request to adjust a stored device trigger 320 associated with the stored trigger ID 314. At 1304, a trigger adjustment procedure may be selected for the stored device trigger based on the trigger adjustment request. For example, determination component 308 of FIG. 3 may be operative to select a trigger replacement procedure or a trigger recall procedure for the stored device trigger 320 based on the trigger adjustment request 310.

At 1306, a first T4 interface command may be sent over a T4 interface connection to initiate the selected trigger adjustment procedure. For example, communications component 306 of FIG. 3 may be operative to send a T4 interface command 324 over T4 interface connection 326 to initiate a selected trigger adjustment procedure for the stored device trigger 320. At 1308, a second T4 interface command that indicates a result of the initiated trigger adjustment procedure may be received over the T4 interface connection. For example, communications component 306 of FIG. 3 may be operative to receive a T4 interface command 332 indicating a result 334 of an initiated trigger adjustment procedure for the stored device trigger 320 over the T4 interface connection 326. At 1310, a trigger adjustment answer may be sent that comprises the result of the initiated trigger adjustment procedure. For example, communications component 306 of FIG. 3 may be operative to send a trigger adjustment answer 338 comprising the result 334 over the Tsp interface connection 312. The embodiments are not limited to these examples.

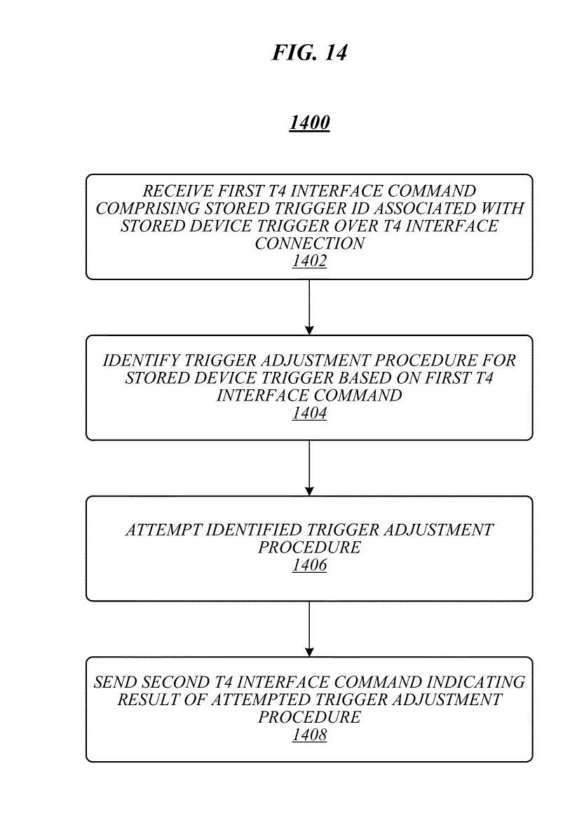

FIG. 14 illustrates a logic flow 1400 such as may be representative of some embodiments. For example, logic flow 1400 may be representative of operations that may be performed in various embodiments by one or more of SMS-SC/GMSC/IWMSC 122 of FIGS. 1 and/or 2, SMS-SC 360 of FIG. 3, and apparatus 700 and/or system 740 of FIG. 7. As shown in logic flow 1400, a first T4 interface command that comprises a stored trigger ID associated with a stored device trigger may be received over a T4 interface connection at 1402. For example, communications component 706 of FIG. 7 may be operative to receive a T4 interface command 724 comprising a stored trigger ID 714 associated with a stored device trigger 720 over a T4 interface connection 726.

At 1404, a trigger adjustment procedure for the stored device trigger may be identified based on the first T4 interface command. For example, determination component 708 of FIG. 7 may be operative to identify a trigger replacement procedure or a trigger recall procedure for the stored device trigger 720 based on the T4 interface command 724. At 1406, the identified trigger adjustment procedure may be attempted. For example, apparatus 700 and/or system 740 of FIG. 7 may be operative to attempt an identified trigger adjustment procedure for the stored device trigger 720. At 1408, a second T4 interface command may be sent that indicates a result of the attempted trigger adjustment procedure. For example, communications component 706 of FIG. 7 may be operative to send a T4 interface command 732 comprising a result 734 of the attempted trigger adjustment procedure for the stored device trigger 720. The embodiments are not limited to these examples.

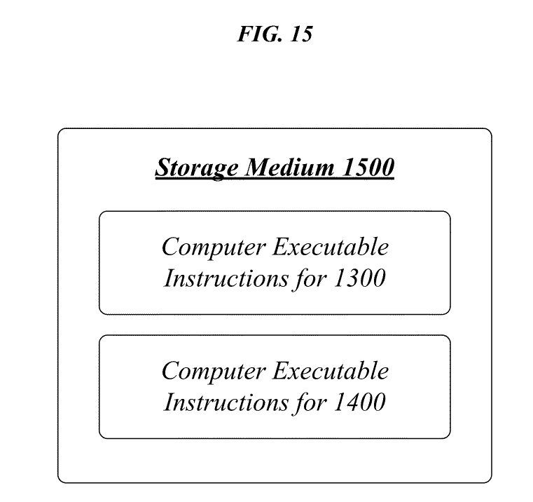

FIG. 15 illustrates an embodiment of a storage medium 1500. Storage medium 1500 may comprise any non-transitory computer-readable storage medium or machine-readable storage medium, such as an optical, magnetic or semiconductor storage medium. In various embodiments, storage medium 1500 may comprise an article of manufacture. In some embodiments, storage medium 1500 may store computer-executable instructions, such as computer-executable instructions to implement logic flow 1300 of FIG. 13 and/or logic flow 1400 of FIG. 14. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

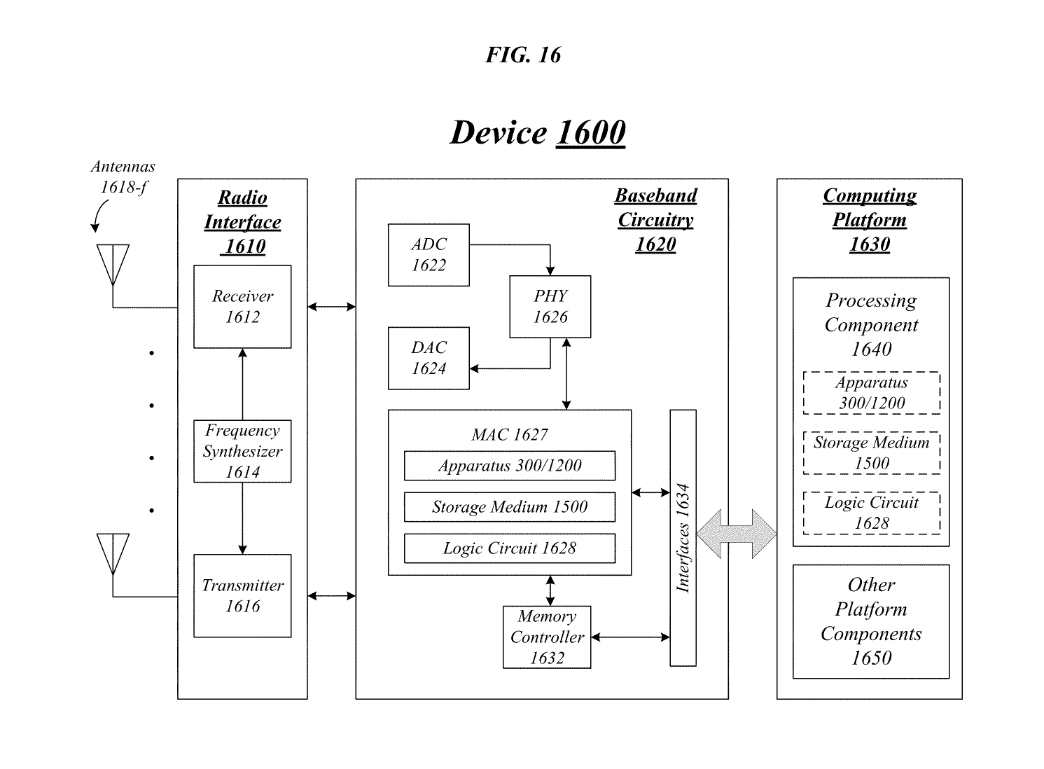

FIG. 16 illustrates an embodiment of a communications device 1600 that may implement one or more of apparatus 300 and/or system 340 of FIG. 3, apparatus 700 and/or system 740 of FIG. 7, logic flow 1300 of FIG. 13, logic flow 1400 of FIG. 14, and storage medium 1500 of FIG. 15. In various embodiments, device 1600 may comprise a logic circuit 1628. The logic circuit 1628 may include physical circuits to perform operations described for one or more of apparatus 300 and/or system 340 of FIG. 3, apparatus 700 and/or system 740 of FIG. 7, logic flow 1300 of FIG. 13, logic flow 1400 of FIG. 14, for example. As shown in FIG. 16, device 1600 may include a radio interface 1610, baseband circuitry 1620, and computing platform 1630, although the embodiments are not limited to this configuration.

The device 1600 may implement some or all of the structure and/or operations for one or more of apparatus 300 and/or system 340 of FIG. 3, apparatus 700 and/or system 740 of FIG. 7, logic flow 1300 of FIG. 13, logic flow 1400 of FIG. 14, storage medium 1500 of FIG. 15, and logic circuit 1628 in a single computing entity, such as entirely within a single device. Alternatively, the device 1600 may distribute portions of the structure and/or operations for one or more of apparatus 300 and/or system 340 of FIG. 3, apparatus 700 and/or system 740 of FIG. 7, logic flow 1300 of FIG. 13, logic flow 1400 of FIG. 14, storage medium 1500 of FIG. 15, and logic circuit 1628 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1610 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1610 may include, for example, a receiver 1612, a frequency synthesizer 1614, and/or a transmitter 1616. Radio interface 1610 may include bias controls, a crystal oscillator and/or one or more antennas 1618-f. In another embodiment, radio interface 1610 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1620 may communicate with radio interface 1610 to process receive and/or transmit signals and may include, for example, an analog-to-digital converter 1622 for down converting received signals, a digital-to-analog converter 1624 for up converting signals for transmission. Further, baseband circuitry 1620 may include a baseband or physical layer (PHY) processing circuit 1626 for PHY link layer processing of respective receive/transmit signals. Baseband circuitry 1620 may include, for example, a medium access control (MAC) processing circuit 1627 for MAC/data link layer processing. Baseband circuitry 1620 may include a memory controller 1632 for communicating with MAC processing circuit 1627 and/or a computing platform 1630, for example, via one or more interfaces 1634.

In some embodiments, PHY processing circuit 1626 may include a frame construction and/or detection module, in combination with additional circuitry such as a buffer memory, to construct and/or deconstruct communication frames. Alternatively or in addition, MAC processing circuit 1627 may share processing for certain of these functions or perform these processes independent of PHY processing circuit 1626. In some embodiments, MAC and PHY processing may be integrated into a single circuit.

The computing platform 1630 may provide computing functionality for the device 1600. As shown, the computing platform 1630 may include a processing component 1640. In addition to, or alternatively of, the baseband circuitry 1620, the device 1600 may execute processing operations or logic for one or more of apparatus 300 and/or system 340 of FIG. 3, apparatus 700 and/or system 740 of FIG. 7, logic flow 1300 of FIG. 13, logic flow 1400 of FIG. 14, storage medium 1500 of FIG. 15, and logic circuit 1628 using the processing component 1640. The processing component 1640 (and/or PHY 1626 and/or MAC 1627) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1630 may further include other platform components 1650. Other platform components 1650 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1600 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1600 described herein, may be included or omitted in various embodiments of device 1600, as suitably desired.

Embodiments of device 1600 may be implemented using single input single output (SISO) architectures. However, certain implementations may include multiple antennas (e.g., antennas 1618-f) for transmission and/or reception using adaptive antenna techniques for beamforming or spatial division multiple access (SDMA) and/or using MIMO communication techniques.

The components and features of device 1600 may be implemented using any combination of discrete circuitry, application specific integrated circuits (ASICs), logic gates and/or single chip architectures. Further, the features of device 1600 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1600 shown in the block diagram of FIG. 16 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

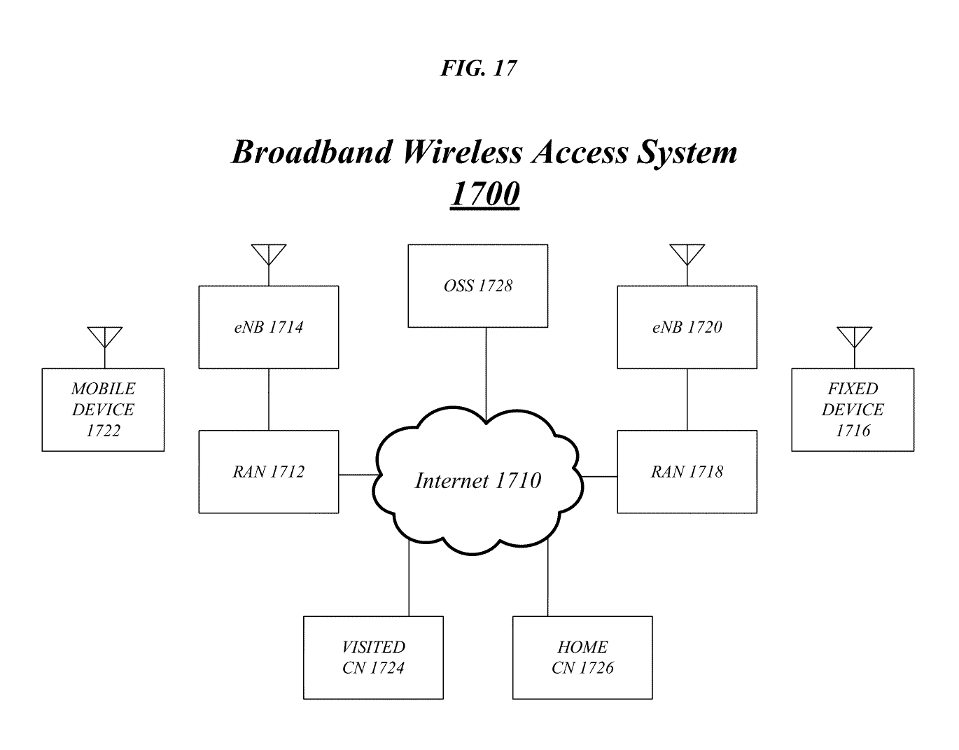

FIG. 17 illustrates an embodiment of a broadband wireless access system 1700. As shown in FIG. 17, broadband wireless access system 1700 may be an internet protocol (IP) type network comprising an internet 1710 type network or the like that is capable of supporting mobile wireless access and/or fixed wireless access to internet 1710. In one or more embodiments, broadband wireless access system 1700 may comprise any type of orthogonal frequency division multiple access (OFDMA)-based or single-carrier frequency division multiple access (SC-FDMA)-based wireless network, such as a system compliant with one or more of the 3GPP LTE Specifications and/or IEEE 802.16 Standards, and the scope of the claimed subject matter is not limited in these respects.

In the exemplary broadband wireless access system 1700, radio access networks (RANs) 1712 and 1718 are capable of coupling with evolved node Bs (eNBs) 1714 and 1720, respectively, to provide wireless communication between one or more fixed devices 1716 and internet 1710 and/or between or one or more mobile devices 1722 and Internet 1710. One example of a fixed device 1716 and a mobile device 1722 is device 1600 of FIG. 16, with the fixed device 1716 comprising a stationary version of device 1600 and the mobile device 1722 comprising a mobile version of device 1600. RANs 1712 and 1718 may implement profiles that are capable of defining the mapping of network functions to one or more physical entities on broadband wireless access system 1700. eNBs 1714 and 1720 may comprise radio equipment to provide RF communication with fixed device 1716 and/or mobile device 1722, such as described with reference to device 1600, and may comprise, for example, the PHY and MAC layer equipment in compliance with a 3GPP LTE Specification or an IEEE 802.16 Standard. eNBs 1714 and 1720 may further comprise an IP backplane to couple to Internet 1710 via RANs 1712 and 1718, respectively, although the scope of the claimed subject matter is not limited in these respects.

Broadband wireless access system 1700 may further comprise a visited core network (CN) 1724 and/or a home CN 1726, each of which may be capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CN 1724 and/or home CN 1726, and the scope of the claimed subject matter is not limited in these respects. Visited CN 1724 may be referred to as a visited CN in the case where visited CN 1724 is not part of the regular service provider of fixed device 1716 or mobile device 1722, for example where fixed device 1716 or mobile device 1722 is roaming away from its respective home CN 1726, or where broadband wireless access system 1700 is part of the regular service provider of fixed device 1716 or mobile device 1722 but where broadband wireless access system 1700 may be in another location or state that is not the main or home location of fixed device 1716 or mobile device 1722. The embodiments are not limited in this context.

Fixed device 1716 may be located anywhere within range of one or both of eNBs 1714 and 1720, such as in or near a home or business to provide home or business customer broadband access to Internet 1710 via eNBs 1714 and 1720 and RANs 1712 and 1718, respectively, and home CN 1726. It is worthy of note that although fixed device 1716 is generally disposed in a stationary location, it may be moved to different locations as needed. Mobile device 1722 may be utilized at one or more locations if mobile device 1722 is within range of one or both of eNBs 1714 and 1720, for example. In accordance with one or more embodiments, operation support system (OSS) 1728 may be part of broadband wireless access system 1700 to provide management functions for broadband wireless access system 1700 and to provide interfaces between functional entities of broadband wireless access system 1700. Broadband wireless access system 1700 of FIG. 17 is merely one type of wireless network showing a certain number of the components of broadband wireless access system 1700, and the scope of the claimed subject matter is not limited in these respects.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Example 1 is a machine-type communication interworking function (MTC-IWF) node, comprising logic, at least a portion of which is in hardware, the logic to receive a trigger adjustment request comprising a stored trigger identifier (ID), the trigger adjustment request constituting a request to adjust a stored device trigger associated with the stored trigger ID, select a trigger adjustment procedure for the stored device trigger based on the trigger adjustment request, and send a first T4 interface command over a T4 interface connection to initiate the selected trigger adjustment procedure.

In Example 2, the first T4 interface command of Example 1 may optionally comprise the stored trigger ID.

In Example 3, the stored trigger ID of any of Examples 1 to 2 may optionally comprise an old trigger reference number corresponding to the stored device trigger.

In Example 4, the logic of any of Examples 1 to 3 may optionally receive a second T4 interface command over the T4 interface connection in response to the first T4 interface command, the second T4 interface command indicating a result of the initiated trigger adjustment procedure.

In Example 5, the first T4 interface command of any of Examples 1 to 4 may optionally comprise a Device-Trigger-Request command.

In Example 6, the first T4 interface command of any of Examples 1 to 5 may optionally include an operation type field comprising a value to indicate a type of the trigger adjustment procedure.

In Example 7, the trigger adjustment procedure of any of Examples 1 to 6 may optionally comprise a trigger replacement procedure.

In Example 8, the first T4 interface command of Example 7 may optionally include an operation type field comprising a value to indicate that the trigger adjustment procedure comprises the trigger replacement procedure.

In Example 9, the trigger adjustment procedure of any of Examples 1 to 6 may optionally comprise a trigger recall procedure.

In Example 10, the first T4 interface command of Example 9 may optionally include an operation type field comprising a value to indicate that the trigger adjustment procedure comprises the trigger recall procedure.

In Example 11, the MTC-IWF node of any of Examples 1 to 10 may optionally comprise a memory unit.

Example 12 is at least one non-transitory computer-readable medium comprising a set of device trigger management instructions that, in response to being executed at a short message service (SMS) service center (SMS-SC) node, cause the SMS-SC node to identify a trigger adjustment procedure for a stored device trigger based on a first T4 interface command received over a T4 interface connection, attempt the identified trigger adjustment procedure, and send a second T4 interface command indicating a result of the attempted trigger adjustment procedure over the T4 interface connection.

In Example 13, the first T4 interface command of Example 12 may optionally comprise a Device-Trigger-Request command.

In Example 14, the second T4 interface command of any of Examples 12 to 13 may optionally comprise a Device-Trigger-Answer command.

In Example 15, the first T4 interface command of any of Examples 12 to 14 may optionally comprise a device trigger identifier (ID) corresponding to the stored device trigger.

In Example 16, the device trigger ID of Example 15 may optionally comprise an old trigger reference number.

In Example 17, the identified trigger adjustment procedure of any of Examples 12 to 16 may optionally comprise a trigger replacement procedure.

In Example 18, the identified trigger adjustment procedure of any of Examples 12 to 16 may optionally comprise a trigger recall procedure.

In Example 19, the at least one non-transitory computer-readable medium of any of Examples 12 to 16 may optionally comprise device trigger management instructions that, in response to being executed at the SMS-SC node, cause the SMS-SC node to include a recall failure error code in the second T4 interface command in response to a failed trigger recall procedure.

In Example 20, the at least one non-transitory computer-readable medium of any of Examples 12 to 16 may optionally comprise device trigger management instructions that, in response to being executed at the SMS-SC node, cause the SMS-SC node to include a replace failure error code in the second T4 interface command in response to a failed trigger replacement procedure.

Example 21 is a device trigger management method, comprising receiving, at a machine-type communication interworking function (MTC-IWF) node comprising a processor circuit, a Device-Action-Request command comprising a request to replace or recall a stored device trigger, sending a first T4 interface command over a T4 interface connection to initiate a procedure to replace or recall the stored device trigger, the first T4 interface command comprising a trigger identifier (ID) corresponding to the stored device trigger, and receiving a second T4 interface command over the T4 interface connection, the second T4 interface command indicating a result of the initiated procedure.

In Example 22, the first T4 interface command of Example 21 may optionally comprise a Device-Trigger-Request command.

In Example 23, the first T4 interface command of any of Examples 21 to 22 may optionally comprise the trigger ID corresponding to the stored device trigger and a trigger ID corresponding to a replacement trigger for the stored device trigger.

In Example 24, the second T4 interface command of any of Examples 21 to 23 may optionally comprise a Device-Trigger-Answer command.

In Example 25, the device trigger management method of any of Examples 21 to 22 may optionally comprise initiating the procedure to replace or recall the stored device trigger based on an operation ID comprised in the Device-Action-Request command.

In Example 26, the device trigger management method of any of Examples 21 to 25 may optionally comprise sending a Device-Action-Answer command indicating the result of the initiated procedure.

Example 27 is at least one non-transitory computer-readable medium comprising a set of instructions that, in response to being executed on a computing device, cause the computing device to perform a device trigger management method according to any of Examples 21 to 26.

Example 28 is an apparatus, comprising means for performing a device trigger management method according to any of Examples 19 to 26.

Example 29 is a system, comprising an apparatus according to Example 28, and a memory unit.

Example 30 is at least one non-transitory computer-readable medium comprising a set of device trigger management instructions that, in response to being executed at a short message service (SMS) service center (SMS-SC) node, cause the SMS-SC node to receive a first T4 interface command over a T4 interface connection, the first T4 interface command comprising a stored trigger identifier (ID) associated with a stored device trigger, identify a trigger adjustment procedure for the stored device trigger based on the first T4 interface command, the trigger adjustment procedure comprising a trigger replacement procedure or a trigger recall procedure, and attempt the identified trigger adjustment procedure.

In Example 31, the at least one non-transitory computer-readable medium of Example 30 may optionally comprise device trigger management instructions that, in response to being executed at the SMS-SC node, cause the SMS-SC node to send a second T4 interface command over the T4 interface connection, the second T4 interface command comprising an information element (IE) that indicates a result of the attempted trigger adjustment procedure.

In Example 32, the second T4 interface command of Example 31 may optionally comprise the stored trigger ID.

In Example 33, the second T4 interface command of any of Examples 31 to 32 may optionally comprise a Device-Trigger-Answer command.

In Example 34, the trigger adjustment procedure of any of Examples 30 to 33 may optionally comprise a trigger replacement procedure, the first T4 interface command comprising a trigger ID associated with a replacement trigger for the stored device trigger.

In Example 35, the first T4 interface command of any of Examples 30 to 34 may optionally comprise a Device-Trigger-Request command.

Example 36 is a device trigger management method, comprising receiving, at a machine-type communication interworking function (MTC-IWF) node comprising a processor circuit, a trigger adjustment request comprising a stored trigger identifier (ID), the trigger adjustment request constituting a request to adjust a stored device trigger associated with the stored trigger ID, selecting, by the processor circuit, a trigger adjustment procedure for the stored device trigger based on the trigger adjustment request, and sending a first T4 interface command over a T4 interface connection to initiate the selected trigger adjustment procedure.

In Example 37, the first T4 interface command of Example 36 may optionally comprise the stored trigger ID.

In Example 38, the stored trigger ID of any of Examples 36 to 37 may optionally comprise an old trigger reference number corresponding to the stored device trigger.

In Example 39, the device trigger management method of any of Examples 36 to 38 may optionally comprise receiving a second T4 interface command over the T4 interface connection in response to the first T4 interface command, the second T4 interface command indicating a result of the initiated trigger adjustment procedure.

In Example 40, the first T4 interface command of any of Examples 36 to 39 may optionally comprise a Device-Trigger-Request command.

In Example 41, the first T4 interface command of any of Examples 36 to 40 may optionally include an operation type field comprising a value to indicate a type of the trigger adjustment procedure.

In Example 42, the trigger adjustment procedure of any of Examples 36 to 41 may optionally comprise a trigger replacement procedure.

In Example 43, the first T4 interface command of Example 42 may optionally include an operation type field comprising a value to indicate that the trigger adjustment procedure comprises the trigger replacement procedure.

In Example 44, the trigger adjustment procedure of any of Examples 36 to 41 may optionally comprise a trigger recall procedure.

In Example 45, the first T4 interface command of Example 44 may optionally include an operation type field comprising a value to indicate that the trigger adjustment procedure comprises the trigger recall procedure.

Example 46 is at least one non-transitory computer-readable medium comprising a set of instructions that, in response to being executed on a computing device, cause the computing device to perform a device trigger management method according to any of Examples 36 to 45.

Example 47 is an apparatus, comprising means for performing a device trigger management method according to any of Examples 36 to 45.

Example 48 is a system, comprising an apparatus according to Example 47, and a memory unit.

Example 49 is a short message service (SMS) service center (SMS-SC) node, comprising logic, at least a portion of which is in hardware, the logic to identify a trigger adjustment procedure for a stored device trigger based on a first T4 interface command received over a T4 interface connection, attempt the identified trigger adjustment procedure, and send a second T4 interface command indicating a result of the attempted trigger adjustment procedure over the T4 interface connection.

In Example 50, the first T4 interface command of Example 49 may optionally comprise a Device-Trigger-Request command.

In Example 51, the second T4 interface command of any of Examples 49 to 50 may optionally comprise a Device-Trigger-Answer command.

In Example 52, the first T4 interface command of any of Examples 49 to 51 may optionally comprise a device trigger identifier (ID) corresponding to the stored device trigger.

In Example 53, the identified trigger adjustment procedure of any of Examples 49 to 52 may optionally comprise a trigger replacement procedure.

In Example 54, the identified trigger adjustment procedure of any of Examples 49 to 52 may optionally comprise a trigger recall procedure.

In Example 55, the logic of any of Examples 49 to 52 may optionally include a recall failure error code in the second T4 interface command in response to a failed trigger recall procedure.

In Example 56, the logic of any of Examples 49 to 52 may optionally include a recall failure error code in the second T4 interface command in response to a failed trigger recall procedure.

In Example 57, the SMS-SC node of any of Examples 49 to 56 may optionally comprise a memory unit.

Example 58 is a machine-type communication interworking function (MTC-IWF) node, comprising logic, at least a portion of which is in hardware, the logic to receive a Device-Action-Request command comprising a request to replace or recall a stored device trigger, send a first T4 interface command over a T4 interface connection to initiate a procedure to replace or recall the stored device trigger, and receive a second T4 interface command over the T4 interface connection, the first T4 interface command comprising a trigger identifier (ID) corresponding to the stored device trigger, the second T4 interface command indicating a result of the initiated procedure.

In Example 59, the first T4 interface command of Example 58 may optionally comprise a Device-Trigger-Request command.

In Example 60, the first T4 interface command of any of Examples 58 to 59 may optionally comprise the trigger ID corresponding to the stored device trigger and a trigger ID corresponding to a replacement trigger for the stored device trigger.

In Example 61, the second T4 interface command of any of Examples 58 to 60 may optionally comprise a Device-Trigger-Answer command.

In Example 62, the logic of any of Examples 58 to 59 may optionally initiate the procedure to replace or recall the stored device trigger based on an operation ID comprised in the Device-Action-Request command.

In Example 63, the logic of any of Examples 58 to 62 may optionally send a Device-Action-Answer command indicating the result of the initiated procedure.

In Example 64, the MTC-IWF node of any of Examples 58 to 63 may optionally comprise a memory unit.

Example 65 is a device trigger management method, comprising receiving, at a short message service (SMS) service center (SMS-SC) node comprising a processor circuit, a first T4 interface command over a T4 interface connection, the first T4 interface command comprising a stored trigger identifier (ID) associated with a stored device trigger, identifying, by the processor circuit, a trigger adjustment procedure for the stored device trigger based on the first T4 interface command, the trigger adjustment procedure comprising a trigger replacement procedure or a trigger recall procedure, and attempting the identified trigger adjustment procedure.

In Example 66, the device trigger management method of Example 65 may optionally comprise sending a second T4 interface command over the T4 interface connection, the second T4 interface command comprising an information element (IE) that indicates a result of the attempted trigger adjustment procedure.

In Example 67, the second T4 interface command of Example 66 may optionally comprise the stored trigger ID.

In Example 68, the second T4 interface command of any of Examples 66 to 67 may optionally comprise a Device-Trigger-Answer command.

In Example 69, the trigger adjustment procedure of any of Examples 65 to 68 may optionally comprise a trigger replacement procedure, the first T4 interface command comprising a trigger ID associated with a replacement trigger for the stored device trigger.

In Example 70, the first T4 interface command of any of Examples 65 to 69 may optionally comprise a Device-Trigger-Request command.

Example 71 is at least one non-transitory computer-readable medium comprising a set of instructions that, in response to being executed on a computing device, cause the computing device to perform a device trigger management method according to any of Examples 65 to 70.

Example 72 is an apparatus, comprising means for performing a device trigger management method according to any of Examples 65 to 70.

Example 73 is a system, comprising an apparatus according to Example 72, and a memory unit.

Example 74 is at least one non-transitory computer-readable medium comprising a set of device trigger management instructions that, in response to being executed at a machine-type communication interworking function (MTC-IWF) node, cause the MTC-IWF node to receive a trigger adjustment request comprising a stored trigger identifier (ID), the trigger adjustment request constituting a request to adjust a stored device trigger associated with the stored trigger ID, select a trigger adjustment procedure for the stored device trigger based on the trigger adjustment request, and send a first T4 interface command over a T4 interface connection to initiate the selected trigger adjustment procedure.

In Example 75, the first T4 interface command of Example 74 may optionally comprise the stored trigger ID.

In Example 76, the stored trigger ID of any of Examples 74 to 75 may optionally comprise an old trigger reference number corresponding to the stored device trigger.

In Example 77, the at least one non-transitory computer-readable medium of any of Examples 74 to 76 may optionally comprise device trigger management instructions that, in response to being executed at the MTC-IWF node, cause the MTC-IWF node to receive a second T4 interface command over the T4 interface connection in response to the first T4 interface command, the second T4 interface command indicating a result of the initiated trigger adjustment procedure.

In Example 78, the first T4 interface command of any of Examples 74 to 77 may optionally comprise a Device-Trigger-Request command.

In Example 79, the first T4 interface command of any of Examples 74 to 78 may optionally include an operation type field comprising a value to indicate a type of the trigger adjustment procedure.

In Example 80, the trigger adjustment procedure of any of Examples 74 to 79 may optionally comprise a trigger replacement procedure.

In Example 81, the first T4 interface command of Example 80 may optionally include an operation type field comprising a value to indicate that the trigger adjustment procedure comprises the trigger replacement procedure.

In Example 82, the trigger adjustment procedure of any of Examples 74 to 79 may optionally comprise a trigger recall procedure.

In Example 83, the first T4 interface command of Example 82 may optionally include an operation type field comprising a value to indicate that the trigger adjustment procedure comprises the trigger recall procedure.

Example 84 is a device trigger management method, comprising identifying, by a processor circuit, a trigger adjustment procedure for a stored device trigger at a short message service (SMS) service center (SMS-SC) node, based on a first T4 interface command received over a T4 interface connection, attempting the identified trigger adjustment procedure, and sending a second T4 interface command indicating a result of the attempted trigger adjustment procedure over the T4 interface connection.

In Example 85, the first T4 interface command of Example 84 may optionally comprise a Device-Trigger-Request command.

In Example 86, the second T4 interface command of any of Examples 84 to 85 may optionally comprise a Device-Trigger-Answer command.

In Example 87, the first T4 interface command of any of Examples 84 to 86 may optionally comprise a device trigger identifier (ID) corresponding to the stored device trigger.

In Example 88, the device trigger ID of Example 87 may optionally comprise an old trigger reference number.

In Example 89, the identified trigger adjustment procedure of any of Examples 84 to 88 may optionally comprise a trigger replacement procedure.

In Example 90, the identified trigger adjustment procedure of any of Examples 84 to 88 may optionally comprise a trigger recall procedure.

In Example 91, the device trigger management method of any of Examples 84 to 88 may optionally comprise including a recall failure error code in the second T4 interface command in response to a failed trigger recall procedure.

In Example 92, the device trigger management method of any of Examples 84 to 88 may optionally comprise including a replace failure error code in the second T4 interface command in response to a failed trigger replacement procedure.

Example 93 is at least one non-transitory computer-readable medium comprising a set of instructions that, in response to being executed on a computing device, cause the computing device to perform a device trigger management method according to any of Examples 84 to 92.

Example 94 is an apparatus, comprising means for performing a device trigger management method according to any of Examples 84 to 92.

Example 95 is a system, comprising an apparatus according to Example 94, and a memory unit.

Example 96 is at least one non-transitory computer-readable medium comprising a set of device trigger management instructions that, in response to being executed on a computing device, cause the computing device to receive a Device-Action-Request command comprising a request to replace or recall a stored device trigger, send a first T4 interface command over a T4 interface connection to initiate a procedure to replace or recall the stored device trigger, the first T4 interface command comprising a trigger identifier (ID) corresponding to the stored device trigger, and receive a second T4 interface command over the T4 interface connection, the second T4 interface command indicating a result of the initiated procedure.

In Example 97, the first T4 interface command of Example 96 may optionally comprise a Device-Trigger-Request command.

In Example 98, the first T4 interface command of any of Examples 96 to 97 may optionally comprise the trigger ID corresponding to the stored device trigger and a trigger ID corresponding to a replacement trigger for the stored device trigger.

In Example 99, the second T4 interface command of any of Examples 96 to 98 may optionally comprise a Device-Trigger-Answer command.

In Example 100, the at least one non-transitory computer-readable medium of any of Examples 96 to 97 may optionally comprise device trigger management instructions that, in response to being executed on the computing device, cause the computing device to initiate the procedure to replace or recall the stored device trigger based on an operation ID comprised in the Device-Action-Request command.

In Example 101, the at least one non-transitory computer-readable medium of any of Examples 96 to 100 may optionally comprise device trigger management instructions that, in response to being executed on the computing device, cause the computing device to send a Device-Action-Answer command indicating the result of the initiated procedure.

Example 102 is a short message service (SMS) service center (SMS-SC) node, comprising logic, at least a portion of which is in hardware, the logic to receive a first T4 interface command over a T4 interface connection, the first T4 interface command comprising a stored trigger identifier (ID) associated with a stored device trigger, the logic to identify a trigger adjustment procedure for the stored device trigger based on the first T4 interface command and attempt the trigger adjustment procedure, the trigger adjustment procedure comprising a trigger replacement procedure or a trigger recall procedure.

In Example 103, the logic of Example 102 may optionally send a second T4 interface command over the T4 interface connection, the second T4 interface command comprising an information element (IE) that indicates a result of the attempted trigger adjustment procedure.

In Example 104, the second T4 interface command of Example 103 may optionally comprise the stored trigger ID.

In Example 105, the second T4 interface command of any of Examples 103 to 104 may optionally comprise a Device-Trigger-Answer command.

In Example 106, the trigger adjustment procedure of any of Examples 102 to 105 may optionally comprise a trigger replacement procedure, the first T4 interface command comprising a trigger ID associated with a replacement trigger for the stored device trigger.

In Example 107, the first T4 interface command of any of Examples 102 to 106 may optionally comprise a Device-Trigger-Request command.

In Example 108, the SMS-SC node of any of Examples 102 to 107 may optionally comprise a memory unit.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A machine-type communication interworking function (MTC-IWF) node, comprising:
logic, at least a portion of which is in hardware, the logic to receive a trigger adjustment request comprising a stored trigger identifier (ID), the trigger adjustment request constituting a request to adjust a stored device trigger associated with the stored trigger ID, select a trigger adjustment procedure for the stored device trigger based on the trigger adjustment request, and send a first T4 interface command over a T4 interface connection to initiate the selected trigger adjustment procedure.

2. The MTC-IWF node of claim 1, the first T4 interface command comprising the stored trigger ID, the stored trigger ID comprising an old trigger reference number corresponding to the stored device trigger.

3. The MTC-IWF node of claim 1, the logic to receive a second T4 interface command over the T4 interface connection in response to the first T4 interface command, the second T4 interface command indicating a result of the initiated trigger adjustment procedure.

4. The MTC-IWF node of claim 1, the first T4 interface command comprising a Device-Trigger-Request command.

5. The MTC-IWF node of claim 1, the trigger adjustment procedure comprising a trigger replacement procedure, the first T4 interface command including an operation type field comprising a value to indicate that the trigger adjustment procedure comprises the trigger replacement procedure.

6. The MTC-IWF node of claim 1, the trigger adjustment procedure comprising a trigger recall procedure, the first T4 interface command including an operation type field comprising a value to indicate that the trigger adjustment procedure comprises the trigger recall procedure.

7. A short message service (SMS) service center (SMS-SC) node, comprising:
logic, at least a portion of which is in hardware, the logic to identify a trigger adjustment procedure for a stored device trigger based on a first T4 interface command received over a T4 interface connection, attempt the identified trigger adjustment procedure, and send a second T4 interface command indicating a result of the attempted trigger adjustment procedure over the T4 interface connection.

8. The SMS-SC node of claim 7, the first T4 interface command comprising a Device-Trigger-Request command.

9. The SMS-SC node of claim 7, the second T4 interface command comprising a Device-Trigger-Answer command.

10. The SMS-SC node of claim 7, the first T4 interface command comprising an old trigger reference number corresponding to the stored device trigger.

11. The SMS-SC node of claim 7, the identified trigger adjustment procedure comprising a trigger replacement procedure.

12. The SMS-SC node of claim 7, the identified trigger adjustment procedure comprising a trigger recall procedure.

13. The SMS-SC node of claim 7, the logic to include a recall failure error code in the second T4 interface command in response to a failed trigger recall procedure.

14. At least one non-transitory computer-readable medium comprising a set of instructions that, in response to being executed on a computing device, cause the computing device to:
receive a Device-Action-Request command comprising a request to replace or recall a stored device trigger;
send a first T4 interface command over a T4 interface connection to initiate a procedure to replace or recall the stored device trigger, the first T4 interface command comprising a trigger identifier (ID) corresponding to the stored device trigger; and
receive a second T4 interface command over the T4 interface connection, the second T4 interface command indicating a result of the initiated procedure.

15. The at least one non-transitory computer-readable medium of claim 14, the first T4 interface command comprising a Device-Trigger-Request command.

16. The at least one non-transitory computer-readable medium of claim 14, the first T4 interface command comprising the trigger ID corresponding to the stored device trigger and a trigger ID corresponding to a replacement trigger for the stored device trigger.

17. The at least one non-transitory computer-readable medium of claim 14, the second T4 interface command comprising a Device-Trigger-Answer command

18. The at least one non-transitory computer-readable medium of claim 14, comprising instructions that, in response to being executed on the computing device, cause the computing device to initiate the procedure to replace or recall the stored device trigger based on an operation ID comprised in the Device-Action-Request command.

19. The at least one non-transitory computer-readable medium of claim 14, comprising instructions that, in response to being executed on the computing device, cause the computing device to send a Device-Action-Answer command indicating the result of the initiated procedure.

20. At least one non-transitory computer-readable medium comprising a set of instructions that, in response to being executed on a computing device, cause the computing device to:
receive a first T4 interface command over a T4 interface connection, the first T4 interface command comprising a stored trigger identifier (ID) associated with a stored device trigger;
identify a trigger adjustment procedure for the stored device trigger based on the first T4 interface command, the trigger adjustment procedure comprising a trigger replacement procedure or a trigger recall procedure; and
attempt the identified trigger adjustment procedure.

21. The at least one non-transitory computer-readable medium of claim 20, comprising instructions that, in response to being executed on the computing device, cause the computing device to send a second T4 interface command over the T4 interface connection, the second T4 interface command comprising an information element (IE) that indicates a result of the attempted trigger adjustment procedure.

22. The at least one non-transitory computer-readable medium of claim 21, the second T4 interface command comprising the stored trigger ID.

23. The at least one non-transitory computer-readable medium of claim 21, the first T4 interface command comprising a Device-Trigger-Request command, the second T4 interface command comprising a Device-Trigger-Answer command.

24. The at least one non-transitory computer-readable medium of claim 20, the trigger adjustment procedure comprising a trigger replacement procedure, the first T4 interface command comprising a trigger ID associated with a replacement trigger for the stored device trigger.

25. The at least one non-transitory computer-readable medium of claim 20, comprising instructions that, in response to being executed on the computing device, cause the computing device to include a replace failure error code in the second T4 interface command in response to a failed trigger replacement procedure.
